(19) United States
(12) Patent Application Publication
(10) Pub. No.: US 2025/0286588 A1
(43) Pub. Date: Sep. 11, 2025

(54) SYSTEMS AND METHODS FOR MITIGATING INTERFERENCE WITHIN ACTIVELY USED SPECTRUM

(71) Applicant: Rearden, LLC, Mountain View, CA (US)

(72) Inventors: Stephen G. Perlman, Palo Alto, CA (US); Antonio Forenza, San Francisco, CA (US); Mario Di Dio, Longmont, CA (US); Fadi Saibi, Sunnyvale, CA (US)

(21) Appl. No.: 19/214,698

(22) Filed: May 21, 2025

Related U.S. Application Data
(63) Continuation of application No. 17/667,230, filed on Feb. 8, 2022, now Pat. No. 12,341,582.
Application No. 17/667,230 is a continuation of application No. 17/361,252, filed on Jun. 28, 2021, now Pat. No. 11,290,162.
Application No. 17/361,252 is a continuation of application No. 15/682,076, filed on Aug. 21, 2017, now Pat. No. 11,050,468.
(60) Provisional application No. 62/380,126, filed on Aug. 26, 2016.

(51) Int. Cl. H04B 7/0456; H04B 7/06; H04B 15/00; H04L 5/14

(52) U.S. Cl. CPC H04B 7/0456; H04B 7/0626; H04B 15/00; H04L 5/14; Y02D 30/70

(57) ABSTRACT

Systems and methods are described to mitigate interference to out of band receivers using out of band training signals.

### CROSS REFERENCE TO RELATED APPLICATIONS

This application is a continuation of co-pending U.S. Pat. No. 17/667,230, filed Feb. 8, 2022, which is a continuation of U.S. patent application Ser. No. 17/361,252, filed Jun. 28, 2021, which is a continuation of U.S. patent application Ser. No. 15/682,076, filed on Aug. 21, 2017, now U.S. Pat. No. 11,050,468, Issued on Jun. 29, 2021, which claims the benefit of U.S. Provisional Patent Application No. 62/380,126, filed Aug. 26, 2016.

U.S. patent application Ser. No. 15/682,076, filed on Aug. 21, 2017, now U.S. Pat. No. 11,050,468, Issued on Jun. 29, 2021, is also a continuation-in-part of U.S. application Ser. No. 14/672,014, entitled “Systems and Methods for Concurrent Spectrum Usage Within Actively Used Spectrum” filed Mar. 27, 2015, now U.S. Pat. No. 11,190,947, Issued On Nov. 30, 2021, which claims the benefit of and priority to U.S. Provisional Patent Application No. 61/980,479, entitled, “Systems and Methods for Concurrent Spectrum Usage Within Actively Used Spectrum” filed Apr. 16, 2014, all of which is herein incorporated by reference.

This application may be related to the following co-pending U.S. Patent Applications and U.S. Provisional Applications:
U.S. application Ser. No. 14/611,565, entitled “Systems and Methods for Mapping Virtual Radio Instances into Physical Areas of Coherence in Distributed Antenna Wireless Systems”
U.S. application Ser. No. 14/086,700, entitled “Systems and Methods for Exploiting Inter-cell Multiplexing Gain in Wireless Cellular Systems Via Distributed Input Distributed Output Technology”
U.S. application Ser. No. 13/844,355, entitled “Systems and Methods for Radio Frequency Calibration Exploiting Channel Reciprocity in Distributed Input Distributed Output Wireless Communications”
U.S. application Ser. No. 13/797,984, entitled “Systems and Methods for Exploiting Inter-cell Multiplexing Gain in Wireless Cellular Systems Via Distributed Input Distributed Output Technology”
U.S. application Ser. No. 13/797,971, entitled “Systems and Methods for Exploiting Inter-cell Multiplexing Gain in Wireless Cellular Systems Via Distributed Input Distributed Output Technology”
U.S. application Ser. No. 13/797,950, entitled “Systems and Methods for Exploiting Inter-cell Multiplexing Gain in Wireless Cellular Systems Via Distributed Input Distributed Output Technology”
U.S. application Ser. No. 13/475,598, entitled “Systems and Methods to enhance spatial diversity in distributed-input distributed-output wireless systems”
U.S. application Ser. No. 13/233,006, entitled “System and Methods for planned evolution and obsolescence of multiuser spectrum”
U.S. application Ser. No. 13/232,996, entitled “Systems and Methods to Exploit Areas of Coherence in Wireless Systems”
U.S. application Ser. No. 12/802,989, entitled “System And Method For Managing Handoff Of A Client Between Different Distributed-Input-Distributed-Output (DIDO) Networks Based On Detected Velocity Of The Client”
U.S. application Ser. No. 12/802,988, entitled “Interference Management, Handoff, Power Control And Link Adaptation In Distributed-Input Distributed-Output (DIDO) Communication Systems”
U.S. application Ser. No. 12/802,975, entitled “System And Method For Link adaptation In DIDO Multicarrier Systems”
U.S. application Ser. No. 12/802,974, entitled “System And Method For Managing Inter-Cluster Handoff Of Clients Which Traverse Multiple DIDO Clusters”
U.S. application Ser. No. 12/802,958, entitled “System And Method For Power Control And Antenna Grouping In A Distributed-Input-Distributed-Output (DIDO) Network”
U.S. Pat. No. 9,386,465, issued Jul. 5, 2016 entitled “System and Method For Distributed Antenna Wireless Communications”
U.S. Pat. No. 9,369,888, issued Jun. 14, 2016 entitled “Systems And Methods To Coordinate Transmissions In Distributed Wireless Systems Via User Clustering”
U.S. Pat. No. 9,312,929, issued Apr. 12, 2016, entitled “System and Methods to Compensate for Doppler Effects in Distributed-Input Distributed Output Systems”
U.S. Pat. No. 8,989,155, issued Mar. 24, 2015, entitled “Systems and Methods for Wireless Backhaul in Distributed-Input Distributed-Output Wireless Systems”
U.S. Pat. No. 8,971,380, issued Mar. 3, 2015, entitled “System and Method for Adjusting DIDO Interference Cancellation Based On Signal Strength Measurements
U.S. Pat. No. 8,654,815, issued Feb. 18, 2014, entitled “System and Method for Distributed Input Distributed Output Wireless Communications”
U.S. Pat. No. 8,571,086, issued Oct. 29, 2013, entitled “System and Method for DIDO Precoding Interpolation in Multicarrier Systems”
U.S. Pat. No. 8,542,763, issued Sep. 24, 2013, entitled “Systems and Methods To Coordinate Transmissions In Distributed Wireless Systems Via User Clustering”
U.S. Pat. No. 8,428,162, issued Apr. 23, 2013, entitled “System and Method for Distributed Input Distributed Output Wireless Communications”
U.S. Pat. No. 8,170,081, issued May 1, 2012, entitled “System And Method For Adjusting DIDO Interference Cancellation Based On Signal Strength Measurements”
U.S. Pat. No. 8,160,121, issued Apr. 17, 2012, entitled, “System and Method For Distributed Input-Distributed Output Wireless Communications”;
U.S. Pat. No. 7,885,354, issued Feb. 8, 2011, entitled “System and Method For Enhancing Near Vertical Incidence Skywave (“NVIS”) Communication Using Space-Time Coding.”
U.S. Pat. No. 7,711,030, issued May 4, 2010, entitled “System and Method For Spatial-Multiplexed Tropospheric Scatter Communications”;
U.S. Pat. No. 7,636,381, issued Dec. 22, 2009, entitled “System and Method for Distributed Input Distributed Output Wireless Communication”;
U.S. Pat. No. 7,633,994, issued Dec. 15, 2009, entitled “System and Method for Distributed Input Distributed Output Wireless Communication”;
U.S. Pat. No. 7,599,420, issued Oct. 6, 2009, entitled “System and Method for Distributed Input Distributed Output Wireless Communication”;
U.S. Pat. No. 7,418,053, issued Aug. 26, 2008, entitled “System and Method for Distributed Input Distributed Output Wireless Communication”.

### BACKGROUND

Both Frequency Division Duplex (“FDD”) and Time Division Duplex (“TDD”) modes are commonly used in wireless communications systems. For example, the LTE standard supports both FDD and TDD modes, as another example 802.11 versions (e.g. Wi-Fi) support TDD mode of operation.

In the case of LTE, various numbered bands are defined within what is called “Evolved UMTS Terrestrial Radio Access” (E-UTRA) air interface. Each E-UTRA band not only specifies a particular band number, but it defines whether the band is FDD or TDD, and what bandwidths are supported within the band (e.g. see http://en.wikipedia.org/wiki/LTE_frequency_bands#Frequency_bands_and_channel_ba ndwidths for a list of E-UTRA bands and their specifications). For example, Band 7 is an FDD band defined as using the frequency ranges of 2,500-2,570 MHz for Uplink (“UL”), 2,620-2,690 for downlink (“DL”), it supports 5, 10, 15, 20 and MHz signal bandwidths within each of the UL and DL bands.

In many cases E-UTRA bands overlap. For example, different bands may be common spectrum that has been allocated in different markets or regions. For example, Band 41 is a TDD band using the frequency ranges of 2,496-2,690 MHz for both UL and DL, which overlaps with both UL and DL ranges in FDD Band 7 (e.g. see FIGS. 16a and 16b. Currently, Band 41 is used in the U.S. by Sprint, while Band 7 is used by Rogers Wireless in the bordering country of Canada. Thus, in the U.S., 2,500-2,570 MHz is TDD spectrum, while in Canada that same frequency range is UL for FDD spectrum.

Typically, a mobile device, upon attaching to a wireless network, will scan through the band searching for transmissions from one or more base stations, and typically during the attach procedure, the base station will transmit the characteristics of the network, such as the bandwidth used by the network, and details of the protocol in use. For example, if an LTE device scans through 2,620-2,690 MHz in the U.S., it might receive an LTE DL frame transmitted by an eNodeB that identifies the spectrum as Band 41, and if the LTE device supports Band 41 and TDD, it may attempt to connect to the eNodeB in TDD mode in that band. Similarly, if an LTE device scans through 2,620-2,690 MHz in the Canada, it might receive an LTE DL frame transmitted by an eNodeB that identifies the spectrum as Band 7, and if the LTE device supports Band 7 and FDD, it may attempt to connect to the eNodeB in FDD mode in Band 7.

Most early LTE networks deployed worldwide used FDD mode (e.g., Verizon, AT&T), but increasingly TDD mode is being used, both in markets with extensive FDD coverage, such as the U.S. (where Sprint is deploying TDD) and in markets that do not yet have extensive LTE coverage, such as China (where China Mobile is deploying TDD). In many cases, a single operator is deploying both FDD and TDD at different frequencies (e.g. Sprint operates both FDD LTE and TDD LTE in different frequencies in the U.S.), and may offer LTE devices which can operate in both modes, depending on which band is used.

Note that the E-UTRA list of LTE bands is by no means a final list, but rather evolves as new spectrum is allocated to mobile operators and devices to use that spectrum are specified. New bands are specified both in spectrum with no current band that overlaps its frequencies, and in spectrum in bands overlapping frequencies of previous band allocations. For example, Band 44, a TDD band spanning 703-803 MHz, was added as an E-UTRA band several years after older 700 MHz FDD bands were specified, such as Bands 12, 13, 14 and 17.

As can be seen in FIG. 6, the bulk of mobile data used to be voice data (e.g. Q1 2007), which is highly symmetric. But, with the introduction of the iPhone in 2007, and the rapid adoption of Android and then introduction of the iPad in 2009, non-voice mobile data rapidly outpaced the growth of voice data, to the point where, by the middle of 2013, voice data was a small fraction of mobile data traffic. Non-voice data is projected to continue to grow exponentially, increasingly dwarfing voice data.

As can been seen in FIG. 7, non-voice mobile data is largely dominated by media, such as streaming video, audio and Web browsing (much of which includes streaming video). Although some streaming media is UL data (e.g. during a videoconference), the vast majority is DL data, resulting is highly asymmetric DL vs. UL data usage. For example, in the Financial Times May 28, 2013 article, “Asymmetry and the impending (US) spectrum crisis”, it states that “ . . . industry estimates of the ratio of data traffic downlink to data traffic in the uplink ranges from a ratio of about eight to one (8:1)—to considerably more.” The article then points out that the largely FDD deployments in the U.S. are very inefficient in handling such asymmetry since FDD mode allocates the same amount of spectrum to each DL and UL. As another example, Qualcomm estimated DL/UL traffic asymmetry as high as 9:1 for one of the U.S. operators, based on 2009 measurements in live networks (cfr., Qualcomm, “1000×: more spectrum—especially for small cells”, November 2013, http://www.qualcomm.com/media/documents/files/1000x-more-spectrum-especially-for-small-cells.pdf). Thus, even when FDD DL spectrum is heavily utilized (potentially to the point of being overloaded), the UL spectrum may be largely unused.

The Financial Times article points out that TDD is far better suited to such asymmetry since it can be configured to allocate far more timeslots to the DL data than the UL data. For example, in the case when 20 MHz is allocated to FDD (as 10+10 MHz), DL data throughput is limited to a maximum of full-time use of 10 MHZ (even when the UL data needs far less than the 10 MHz it has been allocated), whereas when 20 MHz allocated to TDD, DL data throughput can use all 20 MHz the vast majority of the time, allocating the 20 MHz to UL data a small percentage of the time, far better matching the characteristics of data usage today. The article acknowledges that, unfortunately, most existing U.S. mobile spectrum is already committed to FDD mode, but urges the FCC to encourage the use of TDD as it allocates new spectrum.

Although TDD would certainly allow for more efficient use of new spectrum allocations given the increasingly asymmetric nature of mobile data, unfortunately existing FDD networks deployments cannot change operating mode to TDD since the vast majority of users of such LTE FDD networks have devices that only support FDD mode and their devices would cease to be able to connect if the network were switched to TDD mode. Consequently, as LTE data usage becomes increasingly asymmetric, existing LTE FDD networks will see increasing DL congestion, while UL spectrum will be increasingly underutilized (at 8:1 DL:UL ratio, the lower estimate of the May 28, 2013 Financial Times article, that would imply that if the DL channel is fully utilized, only 1/8^{th}, equivalent to 1.25 MHz of 10 Mhz, would be used of the UL channel). This is extremely wasteful and inefficient, particularly given the limited physical existence of practical mobile spectrum (e.g. frequencies that can penetrate walls and propagate well non-line-of-sight, such as ˜450-2600 MHz) and the exponential growth of (increasingly asymmetric) mobile data (e.g. Cisco 2/2013 VNI predicts a 61% CAGR in mobile data growth through 2018, most of which is streaming video and other highly asymmetric data).

### BRIEF DESCRIPTION OF THE DRAWINGS

A better understanding of the present invention can be obtained from the following detailed description in conjunction with the drawings, in which:

FIG. 1 illustrates the general framework of the DIDO Radio Access Network (DRAN)

FIGS. 2A, 2B illustrate the protocol stack of the Virtual Radio Instance (VRI) consistent to the OSI model and LTE standard

FIG. 3 illustrates adjacent DRANs to extend coverage in DIDO wireless networks

FIG. 4 illustrates handoff between DRAN and adjacent wireless networks

FIG. 5 illustrates handoff between DRAN and LTE cellular networks

FIG. 6 is prior art showing voice and non-voice data utilization of mobile spectrum from 2007-2013.

FIG. 7 is prior art showing mobile data traffic share by application type in 2012.

FIG. 8 is a prior art comparison of FDD LTE and TDD LTE modes of operations

FIG. 9 illustrates a new TDD network concurrently using UL spectrum with an existing FDD network

FIG. 10 is a prior art chart of TDD LTE duplex configurations

FIG. 11 illustrates a new TDD network concurrently using DL spectrum with an existing FDD network

FIG. 12 illustrates two new TDD networks concurrently using UL and DL spectrum with an existing FDD network

FIG. 13 illustrates a new FDD network concurrently using UL and DL spectrum with an existing FDD network

FIG. 14 illustrates a DRAN that synthesizes null pCells at the location of base station antennas.

FIGS. 15A, 15B, 15C, and 15D illustrate various propagation scenarios between base station antennas.

FIGS. 16A and 16B are prior art diagrams of allocations of the 2500-2690 MHz band in different regions as either FDD and TDD or only as TDD.

### DETAILED DESCRIPTION

One solution to overcome many of the above prior art limitations is to have user devices concurrently operate in TDD mode in the same spectrum as currently used UL or DL FDD spectrum, such that the TDD spectrum usage is coordinated so as to not conflict with current FDD spectrum usage. Particularly in the FDD UL channel, there is increasingly more unused spectrum, and TDD devices could use that spectrum without impacting the throughput of the existing FDD network. The also enables TDD usage highly propagation-efficient UHF spectrum which, in many regions of the world is almost entirely allocated to FDD, relegating TDD to far less propagation-efficient microwave bands.

In another embodiment is to have user devices concurrently operated in FDD mode in the same spectrum as currently used UL or DL FDD spectrum, such that the UL and DL channels are reversed and each network's spectrum usage is coordinated so as not to conflict with the other network's spectrum usage. Given that the UL channel of each network is increasingly underutilized relative to the DL channel, it allows each network's DL channel to utilize the unused spectrum in the other network's UL channel.

Further, in either embodiment spectral efficiency can be vastly increased by implementing one or both networks using Distributed-Input Distributed-Output (“DIDO”) technology as described in the following patents, patent applications and provisional applications, all of which are assigned the assignee of the present patent and are incorporated by reference. These patents, applications and provisional applications are sometimes referred to collectively herein as the “Related Patents and Applications.”
U.S. patent application Ser. No. 15/682,076, filed on Aug. 21, 2017, entitled “Systems and Methods for Concurrent Spectrum Usage Within Actively Used Spectrum”.
U.S. Provisional Patent Application No. 62/380, 126, filed Aug. 26, 2016, entitled “Systems and Methods for Concurrent Spectrum Usage Within Actively Used Spectrum”.
U.S. application Ser. No. 14/672,014, entitled “Systems And Methods For Concurrent Spectrum Usage Within Actively Used Spectrum”.
U.S. Provisional Patent Application No. 61/980,479, filed Apr. 16, 2014, entitled, “Systems and Methods for Concurrent Spectrum Usage Within Actively Used Spectrum”.
U.S. application Ser. No. 14/611,565, entitled “Systems and Methods for Mapping Virtual Radio Instances into Physical Areas of Coherence in Distributed Antenna Wireless Systems”
U.S. application Ser. No. 14/086,700, entitled “Systems and Methods for Exploiting Inter-cell Multiplexing Gain in Wireless Cellular Systems Via Distributed Input Distributed Output Technology”
U.S. application Ser. No. 13/844,355, entitled “Systems and Methods for Radio Frequency Calibration Exploiting Channel Reciprocity in Distributed Input Distributed Output Wireless Communications”
U.S. application Ser. No. 13/797,984, entitled “Systems and Methods for Exploiting Inter-cell Multiplexing Gain in Wireless Cellular Systems Via Distributed Input Distributed Output Technology”
U.S. application Ser. No. 13/797,971, entitled “Systems and Methods for Exploiting Inter-cell Multiplexing Gain in Wireless Cellular Systems Via Distributed Input Distributed Output Technology”
U.S. application Ser. No. 13/797,950, entitled “Systems and Methods for Exploiting Inter-cell Multiplexing Gain in Wireless Cellular Systems Via Distributed Input Distributed Output Technology”
U.S. application Ser. No. 13/475,598, entitled “Systems and Methods to enhance spatial diversity in distributed-input distributed-output wireless systems”
U.S. application Ser. No. 13/233,006, entitled “System and Methods for planned evolution and obsolescence of multiuser spectrum”
U.S. application Ser. No. 13/232,996, entitled “Systems and Methods to Exploit Areas of Coherence in Wireless Systems”
U.S. application Ser. No. 12/802,989, entitled “System And Method For Managing Handoff Of A Client Between Different Distributed-Input-Distributed-Output (DIDO) Networks Based On Detected Velocity Of The Client”
U.S. application Ser. No. 12/802,988, entitled “Interference Management, Handoff, Power Control And Link Adaptation In Distributed-Input Distributed-Output (DIDO) Communication Systems”
U.S. application Ser. No. 12/802,975, entitled “System And Method For Link adaptation In DIDO Multicarrier Systems”
U.S. application Ser. No. 12/802,974, entitled “System And Method For Managing Inter-Cluster Handoff Of Clients Which Traverse Multiple DIDO Clusters”
U.S. application Ser. No. 12/802,958, entitled “System And Method For Power Control And Antenna Grouping In A Distributed-Input-Distributed-Output (DIDO) Network”
U.S. Pat. No. 9,386,465, issued Jul. 5, 2016 entitled “System and Method For Distributed Antenna Wireless Communications”
U.S. Pat. No. 9,369,888, issued Jun. 14, 2016 entitled “Systems And Methods To Coordinate Transmissions In Distributed Wireless Systems Via User Clustering”
U.S. Pat. No. 9,312,929, issued Apr. 12, 2016, entitled “System and Methods to Compensate for Doppler Effects in Distributed-Input Distributed Output Systems”
U.S. Pat. No. 8,989,155, issued Mar. 24, 2015, entitled “Systems and Methods for Wireless Backhaul in Distributed-Input Distributed-Output Wireless Systems”
U.S. Pat. No. 8,971,380, issued Mar. 3, 2015, entitled “System and Method for Adjusting DIDO Interference Cancellation Based On Signal Strength Measurements
U.S. Pat. No. 8,654,815, issued Feb. 18, 2014, entitled “System and Method for Distributed Input Distributed Output Wireless Communications”
U.S. Pat. No. 8,571,086, issued Oct. 29, 2013, entitled “System and Method for DIDO Precoding Interpolation in Multicarrier Systems”
U.S. Pat. No. 8,542,763, issued Sep. 24, 2013, entitled “Systems and Methods To Coordinate Transmissions In Distributed Wireless Systems Via User Clustering”
U.S. Pat. No. 8,428,162, issued Apr. 23, 2013, entitled “System and Method for Distributed Input Distributed Output Wireless Communications”
U.S. Pat. No. 8,170,081, issued May 1, 2012, entitled “System And Method For Adjusting DIDO Interference Cancellation Based On Signal Strength Measurements”
U.S. Pat. No. 8,160,121, issued Apr. 17, 2012, entitled, “System and Method For Distributed Input-Distributed Output Wireless Communications”;
U.S. Pat. No. 7,885,354, issued Feb. 8, 2011, entitled “System and Method for Enhancing Near Vertical Incidence Skywave (“NVIS”) Communication Using Space-Time Coding.”
U.S. Pat. No. 7,711,030, issued May 4, 2010, entitled “System and Method For Spatial-Multiplexed Tropospheric Scatter Communications”;
U.S. Pat. No. 7,636,381, issued Dec. 22, 2009, entitled “System and Method for Distributed Input Distributed Output Wireless Communication”;
U.S. Pat. No. 7,633,994, issued Dec. 15, 2009, entitled “System and Method for Distributed Input Distributed Output Wireless Communication”;
U.S. Pat. No. 7,599,420, issued Oct. 6, 2009, entitled “System and Method for Distributed Input Distributed Output Wireless Communication”;
U.S. Pat. No. 7,418,053, issued Aug. 26, 2008, entitled “System and Method for Distributed Input Distributed Output Wireless Communication”.

The present invention discloses systems and methods for concurrent spectrum usage within actively used spectrum. Some of the embodiments utilize Distributed-Input Distributed-Output and MU-MAS technology previously disclosed by the assignee of the assignee of the present patent. The disclosures in Section 1 and Section 2 below correspond to the disclosures in the U.S. Provisional Application Ser. No. 61/937,273 filed Feb. 7, 2014, entitled “Systems and Methods for Mapping Virtual Radio Instances into Physical Areas of Coherence in Distributed Antenna Wireless Systems” and relate to the present invention. The disclosures of Sections 3 and 4 below correspond to the disclosures in the U.S. Provisional Application Ser. No. 61/980,479 filed Apr. 16, 2014, entitled “System and Methods for Concurrent Spectrum Usage Within Actively Used Spectrum” and also relate the present invention.

### 1. Systems and Methods for Mapping VRIs into Areas of Coherence

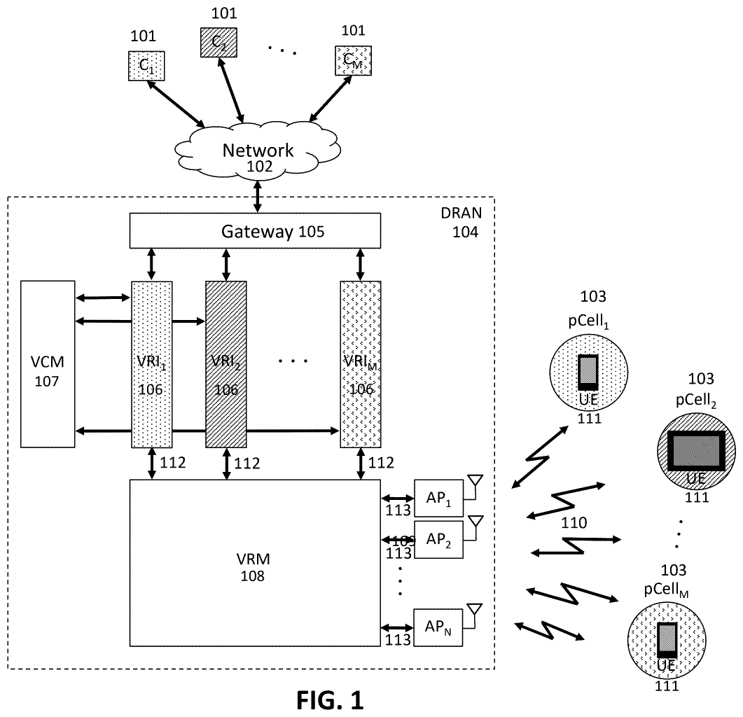

One embodiment of the present invention discloses systems and methods to deliver multiple simultaneous non-interfering data streams within the same frequency band between a network and a plurality of areas of coherence in a wireless link through Virtual Radio Instances (VRIs). In one embodiment the system is a multiuser multiple antenna system (MU-MAS) as depicted in FIG. 1. The color-coded units in FIG. 1 show one-to-one mapping between the data sources 101, the VRIs 106 and the areas of coherence 103 as described hereafter.

### 1.1 Overview of the System Architecture

In FIG. 1, the data sources 101 are data files or streams carrying web content or files in a local or remote server, such as text, images, sounds, videos or combinations of those. One or multiple data files or streams are sent or received between the network 102 and every area of coherence 103 in the wireless link 110. In one embodiment the network is the Internet or any wireline or wireless local area network.

The area of coherence is a volume in space where the waveforms from different antennas of the MU-MAS add up coherently in a way that only the data output 112 of one VRI is received within that area of coherence, without any interference from other data output from other VRIs sent simultaneously over the same wireless link. In the present application we use the term “area of coherence” to describe volumes of coherence or private cells (e.g., “pCells™” 103) as described in our previous patent application [U.S. application Ser. No. 13/232,996, entitled “Systems and Methods to Exploit Areas of Coherence in Wireless Systems”]. In one embodiment, the areas of coherence correspond to the locations of the user equipment (UE) 111 or subscribers of the wireless network, such that every subscriber is associated to one or multiple data sources 101. The areas of coherence may vary in size and shape depending on propagation conditions as well as type of MU-MAS precoding techniques employed to generate them. In one embodiment of the invention, the MU-MAS precoder dynamically adjusts size and shape of the areas of coherence to adapt to the changing propagation conditions while delivering contents to the users with good link reliability.

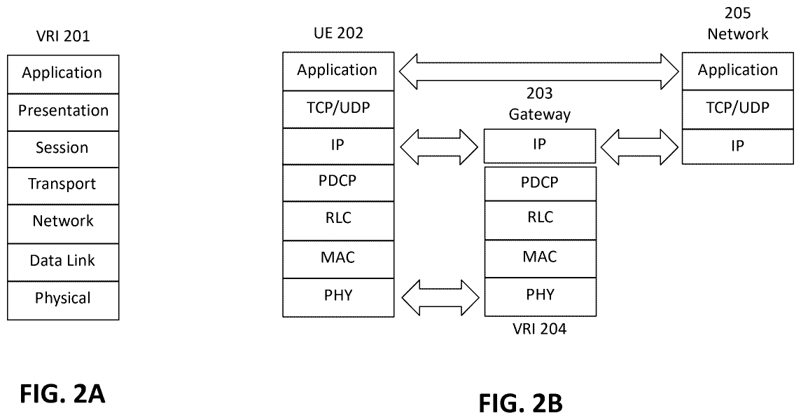

The data sources 101 are first sent through the Network 102 to the DIDO Radio Access Network (DRAN) 104. Then, the DRAN translates the data files or streams into a data format that can be received by the UEs and sends the data files or streams simultaneously to the plurality of areas of coherence, such that every UE receives its own data files or streams without interference from other data files or streams sent to other UEs. The DRAN consists of a gateway 105 as the interface between the network and the VRIs 106. The VRIs translate packets being routed by the gateway into data streams 112, either as raw data, or in a packet or frame structure, that are fed to a MU-MAS baseband unit. In one embodiment, the VRI comprises the open systems interconnection (OSI) protocol stack consisting of sever layers: application, presentation, session, transport, network, data link and physical, as depicted in FIG. 2a. In another embodiment, the VRI only comprises a subset of the OSI layers.

In another embodiment, the VRIs are defined from different wireless standards. By way of example, but not limitation, a first VRI consists of the protocol stack from the GSM standard, a second VRI from the 3G standard, a third VRI from HSPA+standard, a fourth VRI from LTE standard, as fifth VRI from LTE-A standard and a sixth VRI from the Wi-Fi standard. In an exemplary embodiment, the VRIs comprise the control-plane or user-plane protocol stack defined by the LTE standards. The user-plane protocol stack is shown in FIG. 2b. Every UE 202 communicates with its own VRI 204 through the PHY, MAC, RLC and PDCP layers, with the gateway 203 through the IP layer and with the network 205 through the application layer. For the control-plane protocol stack, the UE also communicates directly with the mobility management entity (MME) through the NAS (as defined in the LTE standard stack) layer.

The Virtual Connection Manager (VCM) 107 is responsible for assigning the PHY layer identity of the UEs (e.g., cell-specific radio network temporary identifier, RNTI), authentication and mobility of the VRI and UE. The data streams 112 at the output of the VRIs are fed to the Virtual Radio Manager (VRM) 108. The VRM comprises a scheduler unit (that schedules DL (downlink) and UL (uplink) packets for different UEs), a baseband unit (e.g., comprising of FEC encoder/decoder, modulator/demodulator, resource grid builder) and a MU-MAS baseband processor (comprised of precoding logic for implementing precoding operations). In one embodiment, the data streams 112 are I/Q samples at the output of the PHY layer in FIG. 2b that are processed by the MU-MAS baseband processor. In a different embodiment, the data streams 112 are MAC, RLC or PDCP packets sent to a scheduler unit that forwards them to a baseband unit. The baseband unit converts packets into I/Q fed to the MU-MAS baseband processor.

The MU-MAS baseband processor is the core of the VRM that converts the M I/Q samples from the M VRIs into N data streams 113 sent to N access points (APs) 109. In one embodiment, the data streams 113 are I/Q samples of the N waveforms transmitted over the wireless link 110 from the APs 109. In this embodiment the AP consists of ADC/DAC, RF chain and antenna. In a different embodiment, the data streams 113 are bits of information and MU-MAS precoding information that are combined at the APs to generate the N waveforms sent over the wireless link 110. In this embodiment every AP is equipped with CPU, DSP or SoC to carry out additional baseband processing before the ADC/DAC units.

### 1.2 Supporting Mobility and Handoff

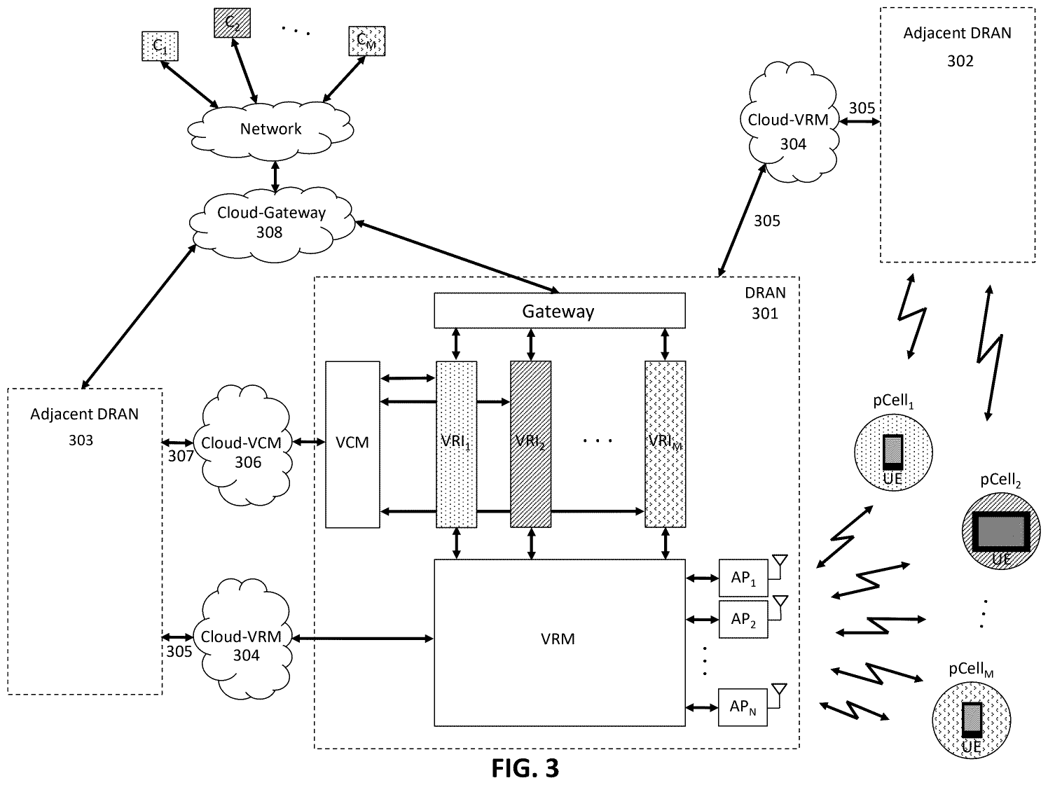

The systems and methods described thus far work as long the UEs are within reach of the APs. When the UEs travel away from the AP coverage area the link may drop and the DRAN 301 is unable to create areas of coherence. To extend the coverage area, the systems can gradually evolve by adding new APs. There may not be enough processing power in the VRM, however, to support the new APs or there may be practical installation issues to connect the new APs to the same VRM. In these scenarios, it is necessary to add adjacent DRANs 302 and 303 to support the new APs as depicted in FIG. 3.

In one embodiment a given UE is located in the coverage area served by the first DRAN 301 and the adjacent DRAN 302. In this embodiment, the adjacent DRAN 302 only carries out MU-MAS baseband processing for that UE, jointly with the MU-MAS processing from the first DRAN 301. No VRI is handled by the adjacent DRAN 302 for the given UE, since the VRI for that UE is already running within the first DRAN 301. To enable joint precoding between the first and adjacent DRANs, baseband information is exchanged between the VRM in the first DRAN 301 and the VRM in the adjacent DRAN 302 through the cloud-VRM 304 and the links 305. The links 305 are any wireline (e.g., fiber, DSL, cable) or wireless link (e.g., line-of-sight links) that can support adequate connection quality (e.g. low enough latency and adequate data rate) to avoid degrading performance of the MU-MAS precoding.

In a different embodiment a given UE moves out of the coverage area of the first DRAN 301 into the coverage area of the adjacent DRAN 303. In this embodiment the VRI associated to that UE is “teleported” from the first DRAN 301 to the adjacent DRAN 303. What is meant by the VRI being teleported or “VRI teleportation” is the VRI state information is transferred from DRAN 301 to DRAN 303, and the VRI ceases to execute within DRAN 301 and begins to execute within DRAN 303. Ideally, the VRI teleportation occurs fast enough that, from the perspective of the UE served by the teleported VRI, it does not experience any discontinuity in its data stream from the VRI. In one embodiment, if there is a delay before the VRI is fully executing after being teleported, then before the VRI teleportation begins, the UE served by that VRI is put into a state where it will not drop its connection or otherwise enter an undesirable state until the VRI starts up at the adjacent DRAM 303, and the UE once again is served by an executing VRI. “VRI teleportation” is enabled by the cloud-VCM 306 that connects the VCM in the first DRAN 301 to the VCM in the adjacent DRAN 303. The wireline or wireless links 307 between VCM do not have the same restrictive constraints as the links 305 between VRMs since they only carry data and do not affect performance of the MU-MAS precoding. In the same embodiment of the invention, additional links 305 are employed between the first DRAN 301 and the adjacent DRAN 303 to connect their VRMs that can support adequate connection quality (e.g., low enough latency and adequate data rate) to avoid degrading performance of the MU-MAS precoding. In one embodiment of the invention, the gateways of the first and adjacent DRANs are connected to the cloud-gateway 308 that manages all network address (or IP address) translation across DRANs.

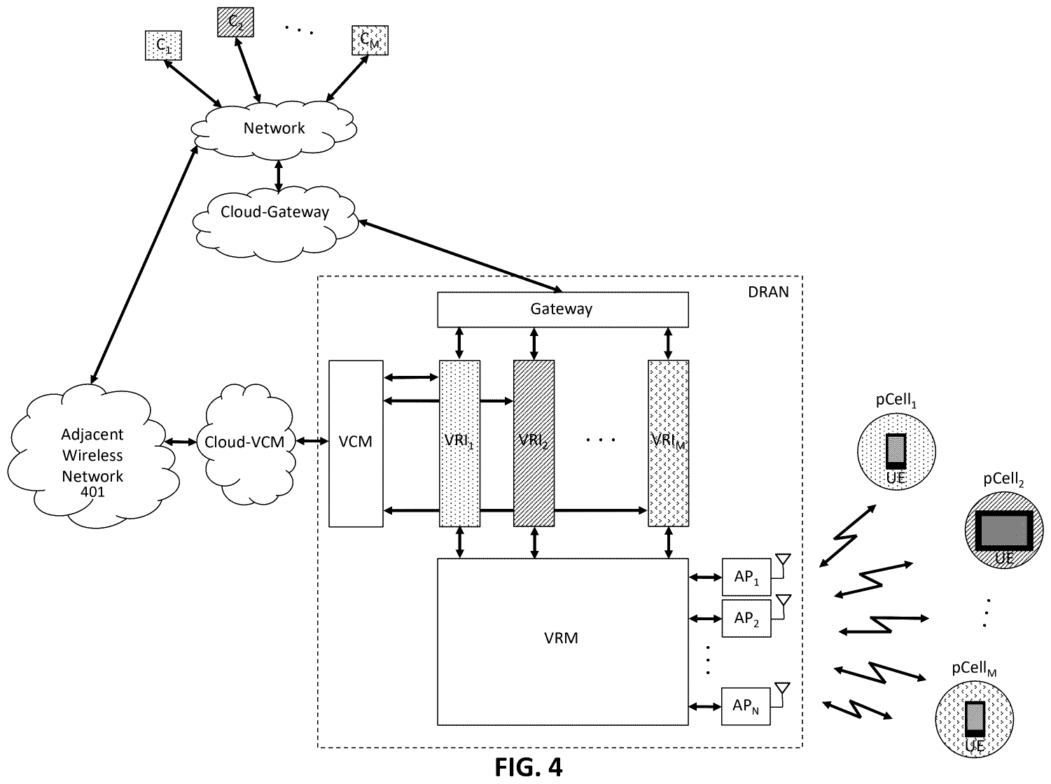

In one embodiment of the invention, VRI teleportation occurs between the DRAN network disclosed in the present application and any adjacent wireless network 401 as depicted in FIG. 4. By way of example, but not limitation, the wireless network 401 is any conventional cellular (e.g., GSM, 3G, HSPA+, LTE, LTE-A) or wireless local area network (WLAN, e.g., Wi-Fi). As the VRI is teleported from the DRAN to the adjacent wireless network 401 the UE is handed off between the two networks and its wireless connection may continue.

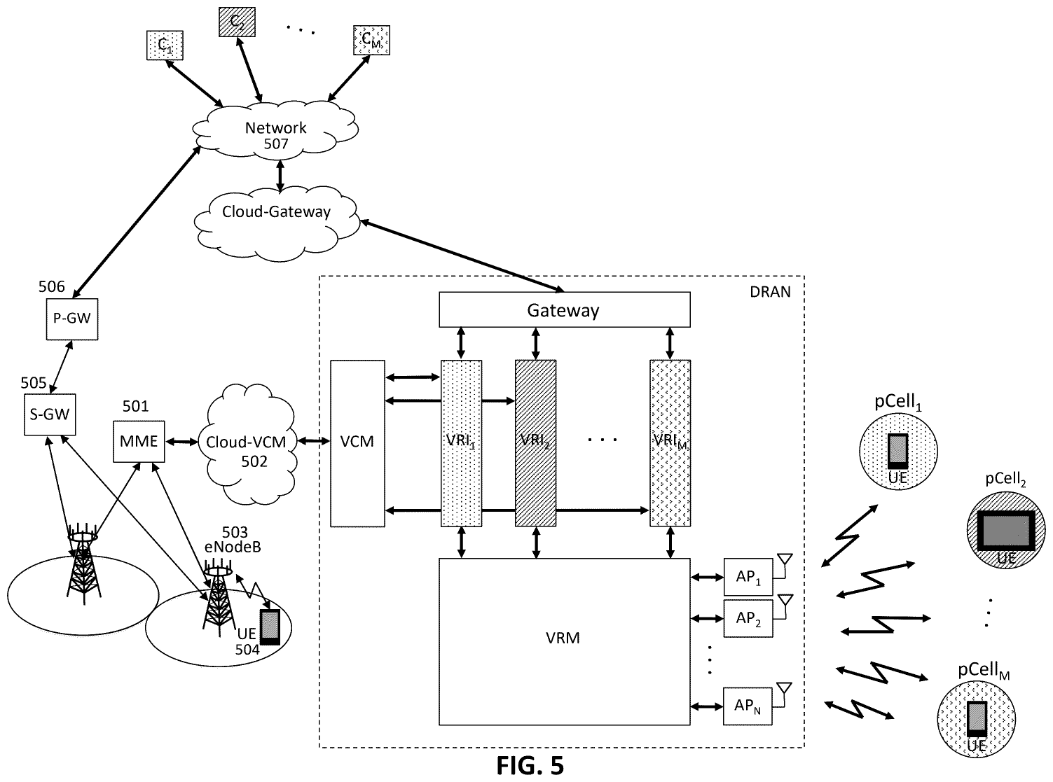

In one embodiment, the adjacent wireless network 401 is the LTE network shown in FIG. 5. In this embodiment, the Cloud-VCM 502 is connected to the LTE mobility management entity (MME) 501. All the information about identity, authentication and mobility of every UE handing-off between the LTE and the DRAN networks is exchanged between the MME 501 and the cloud-VCM 502. In the same embodiment, the MME is connected to one or multiple eNodeBs 503 connecting to the UE 504 through the wireless cellular network. The eNodeBs are connected to the network 507 through the serving gateway (S-GW) 505 and the packet data network gateway (P-GW) 506.

### 2. Systems and Methods for DL and UL MU-MAS Processing

Typical downlink (DL) wireless links consist of broadcast physical channels carrying information for the entire cell and dedicated physical channels with information and data for given UE. For example, the LTE standard defines broadcast channels such as P-SS and S-SS (used for synchronization at the UE), MIB and PDCCH as well as channels for carrying data to given UE such as the PDSCH. In one embodiment of the present invention, all the LTE broadcast channels (e.g., P-SS, S-SS, MIC, PDCCH) are precoded such that every UE receives its own dedicated information. In a different embodiment, part of the broadcast channel is precoded and part is not. By way of example, but not limitation, the PDCCH contains broadcast information as well as information dedicated to one UE, such as the DCI 1A and DCI 0 used to point the UEs to the resource blocks (RBs) to be used over DL and uplink (UL) channels. In one embodiment, the broadcast part of the PDCCH is not precoded, whereas the portion containing the DCI 1A and 0 is precoded in such a way that every UE obtains its own dedicated information about the RBs that carry data.

In another embodiment of the invention, precoding is applied to all or only part of the data channels, such as the PDSCH in LTE systems. By applying precoding over the entire data channel, one embodiment of the MU-MAS disclosed in the present application allocates the entire bandwidth to every UE and the plurality of data streams of the plurality of UEs are separated via spatial processing. In typical scenarios, however, most, if not all, of the UEs do not need the entire bandwidth (e.g., ˜70 Mbps per UE, peak data rate for TDD configuration #2 in 20 MHz of spectrum). Then, one embodiment of the MU-MAS in the present application subdivides the DL RBs in multiple blocks as in OFDMA systems and assigns each block to a subset of UEs. All the UEs within the same block are separated through the MU-MAS precoding. In another embodiment, the MU-MAS allocates different DL subframes to different subsets of UEs, thereby dividing up the DL as in TDMA systems. In yet another embodiment, the MU-MAS both subdivides the DL RBs in multiple blocks as in OFDMA systems among subsets of UEs and also allocates different DL subframes to different subsets of UEs as in TDMA systems, thus utilizing both OFDMA and TDMA to divide up the throughput. For example, if there are 10 APs in a TDD configuration #2 in 20 MHz, then there is an aggregate DL capacity of 70 Mbps*10=700 Mbps. If there are 10 UEs, then each UE could receive 70 Mbps concurrently. If there are 200 UEs, and the aggregate throughput is to be divided up equally, then using OFDMA, TDMA or a combination thereof, the 200 UEs would be divided into 20 groups of 10 UEs, whereby each UE would receive 700 Mbps/200=3.5 Mbps. As another example, if 10 UEs required 20 Mbps, and the other UEs were to evenly share the remaining throughput, then 20 Mbps*10-200 Mbps of the 700 Mbps would be used for 10 UEs, leaving 700 Mbps-200 Mbps=500 Mbps to divide among the remaining 200−10=190 UEs. As such, each of the remaining 90 UEs would receive 500 Mbps/190=2.63 Mbps. Thus, far more UEs than APs can be supported in the MU-MAS system, and the aggregate throughput of all the APs can be divided among the many UEs.

In the UL channel, the LTE standard defines conventional multiple access techniques such as TDMA or SC-FDMA. In one embodiment of the present invention, the MU-MAS precoding is enabled over the DL in a way to assign UL grants to different UEs to enable TDMA and SC-FDMA multiple access techniques. As such, the aggregate UL throughput can be divided among far more UEs than there are APs.

When there are more UEs than there are APs and the aggregate throughput is divided among the UEs, as described above, in one embodiment, the MU-MAS system supports a VRI for each UE, and the VRM controls the VRIs such that VRIs utilize RBs and resource grants in keeping with the chosen OFDMA, TDMA or SC-FDMA system(s) used to subdivide the aggregate throughput. In another embodiment, one or more individual VRIs may support multiple UEs and manage the scheduling of throughput among these UEs via OFDMA, TDMA or SC-FDMA techniques.

In another embodiment, the scheduling of throughput is based on load balancing of user demand, using any of many prior art techniques, depending upon the policies and performance goals of the system. In another embodiment, scheduling is based upon Quality of Service (QoS) requirements for particular UEs (e.g., that pay for a particular tier of service, guaranteeing certain throughput levels) or for particular types of data (e.g. video for a television service).

In a different embodiment, UL receive antenna selection is applied to improve link quality. In this method, the UL channel quality is estimated at the VRM based on signaling information sent by the UEs (e.g., SRS, DMRS) and the VRM decides the best receive antennas for different UEs over the UL. Then the VRM assigns one receive antenna to every UE to improve its link quality. In a different embodiment, receive antenna selection is employed to reduce cross-interference between frequency bands due to the SC-FDMA scheme. One significant advantage of this method is that the UE would transmit over the UL only to the AP closest to its location. In this scenario, the UE can significantly reduce its transmit power to reach the closest AP, thereby improving battery life. In the same embodiment, different power scaling factors are utilized for the UL data channel and for the UL signaling channel. In one exemplary embodiment, the power of the UL signaling channel (e.g., SRS) is increased compared to the data channel to allow UL CSI estimation and MU-MAS precoding (exploiting UL/DL channel reciprocity in TDD systems) from many APs, while still limiting the power required for UL data transmission. In the same embodiment, the power levels of the UL signaling and UL data channels are adjusted by the VRM through DL signaling based on transmit power control methods that equalize the relative power to/from different UEs.

In a different embodiment, maximum ratio combining (MRC) is applied at the UL receiver to improve signal quality from every UE to the plurality of APs. In a different embodiment zero-forcing (ZF) or minimum mean squared error (MMSE) or successive interference cancellation (SIC) or other non-linear techniques or the same precoding technique as for the DL precoding are applied to the UL to differentiate data streams being received from different UEs' areas of coherence. In the same embodiment, receive spatial processing is applied to the UL data channel (e.g., PUSCH) or UL control channel (e.g., PUCCH) or both.

### 3. Systems and Methods for Concurrent Spectrum Usage Within Actively Used Spectrum

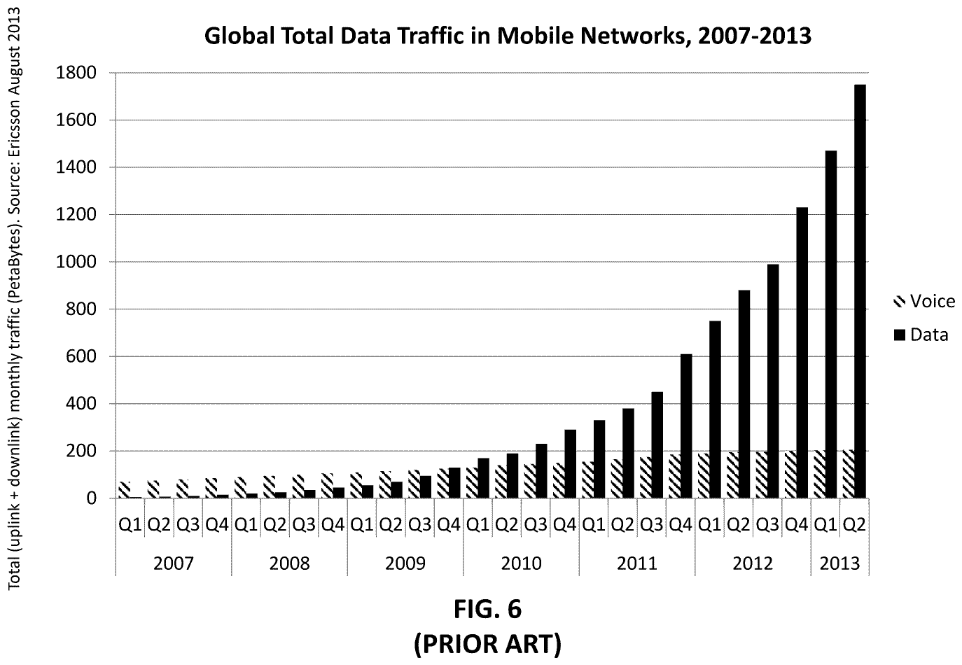

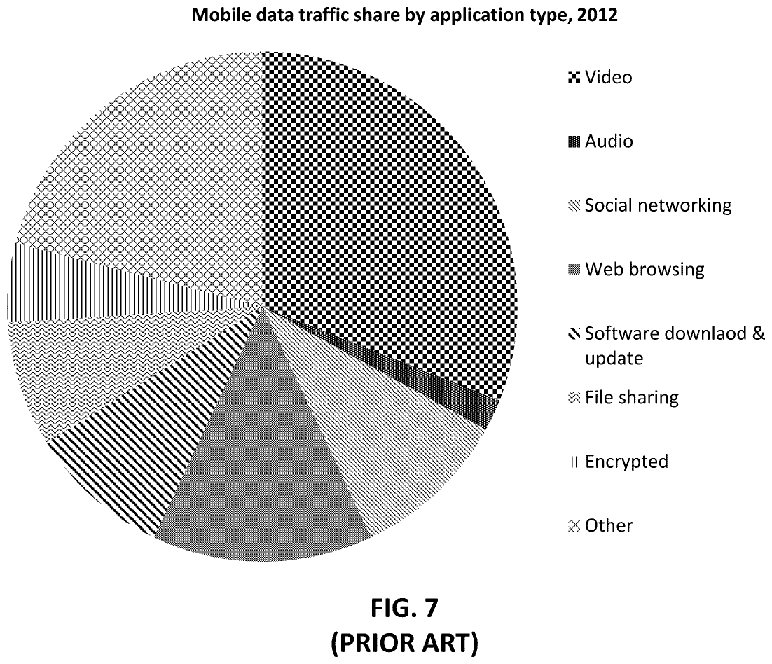

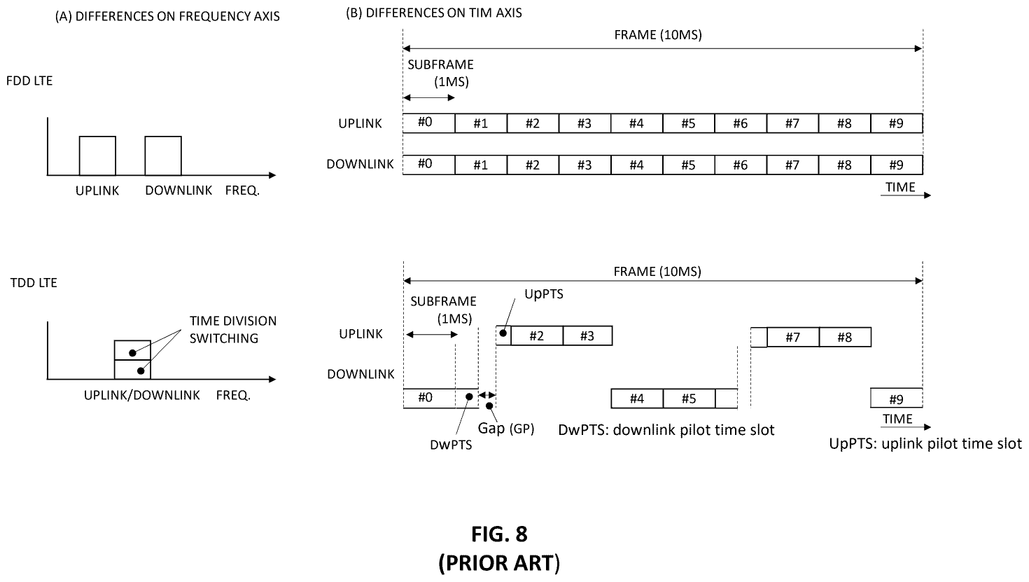

As detailed in the Background section above, and shown in FIG. 6 and FIG. 7 mobile data usage has changed dramatically from being dominated by largely symmetric voice data to highly asymmetric non-voice data, particularly media such as video streaming. Most mobile LTE deployments worldwide are FDD LTE, whose physical layer structure is illustrated in the upper half of FIG. 8, which have fixed, symmetric uplink (“UL”) and downlink (“DL”) channels, and as a result, as the DL channels have become increasingly congested with exponential growth of DL data relative to UL data, the UL data channels have been increasingly underutilized.

The LTE standard also supports TDD LTE (also called “TD-LTE”) whose physical layer structure is illustrated in the lower half of FIG. 8, and the mobile operator can choose whether the UL and DL channels are symmetric (as shown in this illustration) or asymmetric (e.g. with more subframes allocated to either the DL or UL channel), and as a result, as the DL channels become increasingly congested with exponential growth of DL data relative to UL data, the mobile operator can choose to allocate more subframes to DL than to UL. For example, in one configuration TD-LTE supports an 8:1 DL:UL ratio, allocating 8 times as many subframes to DL as to UL.

Other than the fact that TD-LTE is bi-directional in one channel, the structure and details of TD-LTE and FDD LTE are almost identical. In both modes every frame has 10 ms duration and consists of ten subframes of 1 ms each. The modulation and coding schemes are almost identical, and the upper layers of the protocol stack are effectively the same. In both cases, the time and frequency reference for the user equipment (“UE”) devices (e.g. mobile phones, tablets) is provided by the eNodeB (the LTE base station protocol stack) to all devices (via the DL channel with FDD LTE and during DL subframes with TD-LTE).

Notably, in the case of both FDD and TDD LTE, the network can be configured so that a UE may only transmit UL data when given a grant to do so by the eNodeB, received through a DL transmission. As such, the eNodeB not only controls when it transmits DL data, but it also controls when UEs may transmit UL data.

Also, notably, in the case of an LTE FDD UE, its receiver is only tuned to its DL channel and has no receiver tuned to its UL channel. As such an FDD UE is “deaf” to anything that is transmitted in its UL channel by another device.

And, in the case of all LTE UEs, whether FDD or TDD, even to the extent their receivers are tuned to a particular channel, other than certain control signals intended for all UEs (or for a given UE) which maintain their time reference and connection to the network, or give them directions at what time and frequency they are to receive data, they ignore DL data not intended to them. Or to put it another way, the only relevant DL data to an LTE UE is data that is either control information or is data that is directed to the UE. During other times, whether the channel is utilized with a DL to another UE, not utilized at all or utilized for a purpose that falls outside of the LTE standard, the UE is “deaf” to any DL transmissions that are not control information or DL data directed to that UE. Thus, LTE receivers, whether FDD or TDD, only receive control data intended for all UEs or for a given UE, or receive data for a given UE. Other transmissions in the DL channel are ignored.

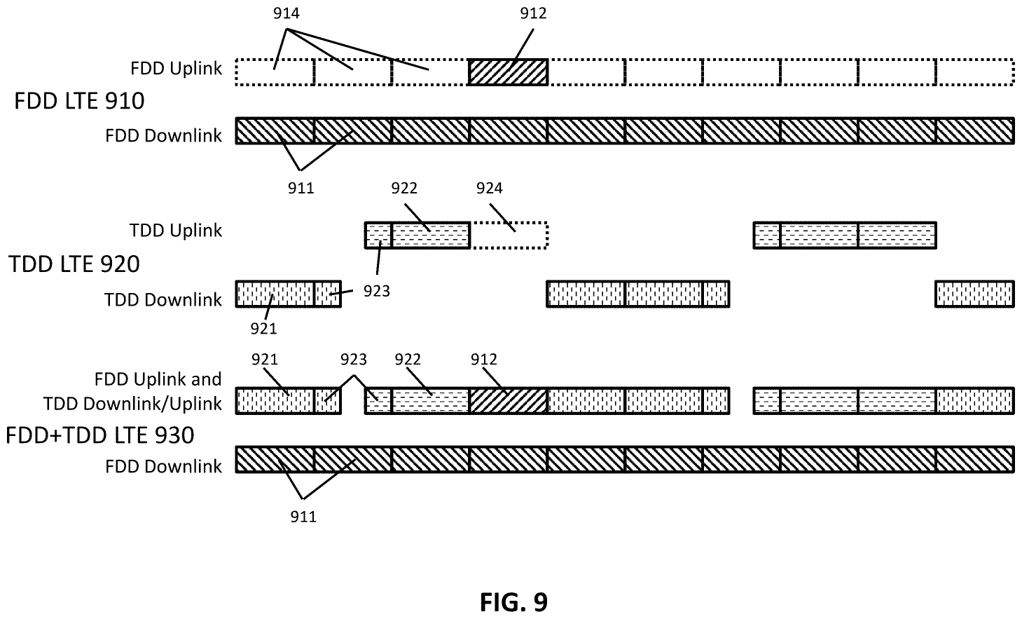

FIG. 9 illustrates how an FDD and TDD network can concurrently utilize actively utilize FDD spectrum. The top two lines of boxes labeled “FDD LTE 910” illustrate one LTE frame interval (10 ms) made up of ten 1 ms subframe intervals, in both the Uplink (“UL”) and Downlink (“DL”) channels. This illustration shows the type of asymmetric data transmission that is increasingly more typical (e.g. downlink streaming video) where there is far more DL data than UL data. Boxes with solid outlines filled with slanted lines (e.g. box 912 and boxes 911) indicate subframes where data is being transmitted, boxes with dotted outlines that are blank (e.g. boxes 914) show “idle” subframes were no data is being transmitted (i.e. there are no transmissions in the channel during that subframe interval). Boxes 911 are 2 of the 10 DL subframes, all of which are full of data. Box 912 shows 1 UL subframe which has data. And boxes 914 are 3 of the 9 idle UL subframes which have no data transmissions.

The middle two lines of boxes in FIG. 9 labeled “TDD LTE 920” illustrate one LTE frame interval (10 ms) made up of 10 1 ms subframe intervals, including 2 “Special” subframe intervals, but unlike the FDD LTE 910 lines, both lines of boxes in the TDD LTE 920 line not only share the same spectrum with each other, but they share the same spectrum as the FDD Uplink. This illustration shows asymmetric data transmission where there are 4 DL subframes and 3 UL subframes transmitting data. Boxes with solid outlines filled with dashed lines (e.g. box 921, box 922 and box 923) indicate subframes where data is being transmitted, the box with a dotted outline that is blank (i.e. box 924) shows an idle subframe were no data is being transmitted (i.e. there are no transmissions in the channel during that subframe interval). Box 921 is 1 of 4 DL subframes, all of which are full of data. Box 922 shows 1 of 3 UL subframes all of which have data. Box 924 is the 1 idle UL subframe which is empty.

The third two lines of boxes in FIG. 9 labeled “FDD+TDD LTE 930” illustrate one LTE frame interval (10 ms) made up of 10 1 ms subframe intervals, including 2 “Special” subframe intervals, and shows the concurrent operation of the FDD LTE 910 system and the TDD LTE 920 system, with the TDD LTE 920 system sharing the same spectrum as the FDD LTE 910 Uplink. The two systems do not interfere with each other because, (a) during the subframe interval 912 where the FDD LTE 910 system has UL data transmission, the TDD LTE 920 system has an idle interval 924 when it is neither an UL or DL and (b) during the subframe intervals where the TDD LTE 920 system has transmissions in either the UL or DL direction (e.g. 921, 923 and 922), the FDD LTE 910 system has idle UL intervals (e.g. idle UL subframes 914) with no UL data transmissions. Thus, the two systems coexist using the same spectrum with no interference between them.

For FDD LTE 910 and TDD LTE 920 networks to concurrently use the same spectrum, their operation must be coordinated by either one eNodeB that is set up to operate two spectrum sharing networks concurrently, or by the coordination of an eNodeB operating the existing TDD LTE 920 network and a second network controller that could be a second eNodeB or another system compatible with LTE timing and frame structure, such as the Distributed-Input Distributed-Output Distributed antenna MU-MAS C-RAN system disclosed in Sections 1 and 2 above and in the Related Patents and Applications. In any of these cases, both the frames of the FDD LTE 910 and TDD LTE 920 systems have to be synchronized, not only in terms of timing, but in terms of subframe resource allocations. For example, in the case of FIG. 9, the system controlling the FDD LTE 910 system will need to be aware of which subframes are TDD UL subframes that are available to be used for UL (e.g. will not conflict with TDD DL control signals sent over subframes #0 and #5 for time and frequency synchronization at the UE), and use one of those subframes for its FDD UL subframe 912. If the same system is also controlling the TDD LTE 920 system, it will also have to be sure not to schedule an UL from a TDD device during that subframe 912, and if it is not controlling the TDD LTE 920 system, it will have to notify whatever system is controlling the TDD LTE 920 system to not schedule an UL from a TDD device during that subframe 912. Of course, it may be the case that the FDD LTE 910 system requires more than one UL subframe during a frame time, and if so, its controller would use any or all of the 3 TDD LTE 920 subframes 922 for its UL subframes, appropriately controlling or notifying as described above. Note that it may be the case that in some 10 ms frames all of the UL subframes are allocated to one of the networks and the other network gets no UL subframes. LTE devices do not expect to be able to transmit UL data every frame time (e.g. when an LTE network is congested, an LTE device may wait many frame times before it is granted even a portion of a UL subframe), so one embodiment of the present invention will function when all of the available TDD LTE 920 UL subframes in a given frame are utilized by one network (i.e. “starving” the other network of UL subframes). However, starving one network for too many successive frames or allowing too few UL frames in aggregate will result in poor network performance (e.g., low UL throughput, or high round-trip latency) and, at some point, if the LTE devices attached to the network seeking to transmit UL data may determine the network is not usable and disconnect. As such, establishing appropriate scheduling priorities and paradigms to balance the UL subframe resources between the FDD LTE 910 and TDD LTE 920 networks may result in the best overall network performance and user (and/or UE) experience.

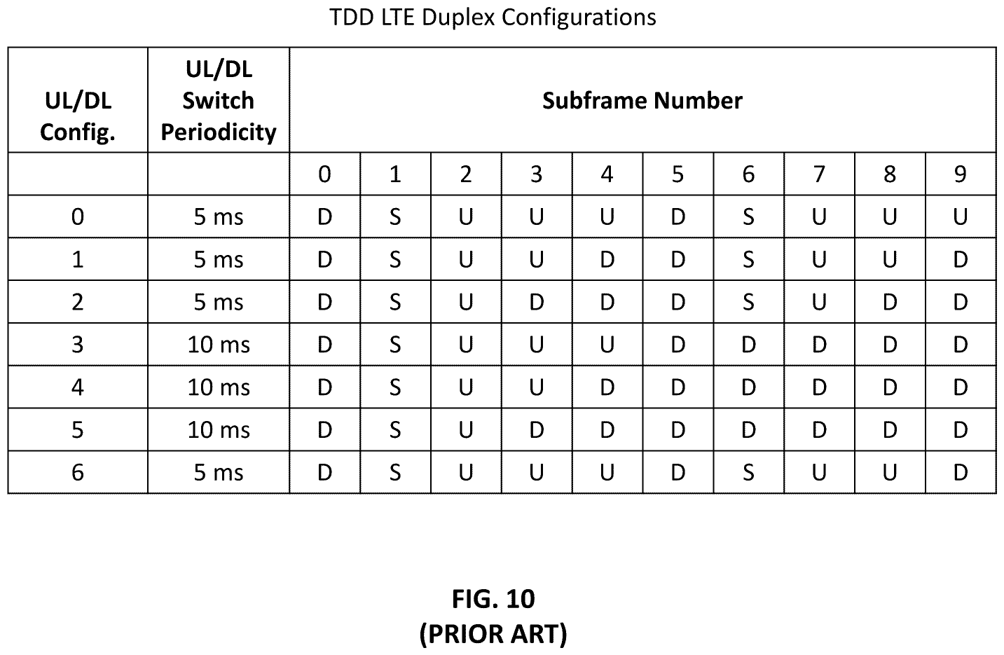

One tool that is available for balancing the UL subframe resources (and to meet network operator priorities) that is not available in a standalone FDD LTE system are the TDD LTE Duplex Configurations shown in FIG. 10. FIG. 9 illustrates TDD LTE 920 system TDD LTE Duplex Configuration 1, in which during the 10 subframes in the 10 ms frame, there are 4 UL subframes, 4 DL subframes and 2 Special subframes. As can be seen in FIG. 10, there are several TDD LTE Duplex Configurations which can be used, depending on the mobile operator's needs and data traffic patterns, and for balancing the UL subframe resources with the FDD LTE 910 network needs. The TDD LTE Duplex Configuration can also be changed over time as data traffic patterns change. Any of the TDD LTE Duplex Configurations can be used with the embodiments of the invention. For example, in Configuration 1, as shown in FIG. 9, 1 UL subframe has been allocated to the FDD network and 3 UL subframes have been assigned to the TDD network. If the FDD network had a sudden need for more UL throughput, then 2 UL subframes can be allocated for FDD, leaving 2 for TDD, the very next frame time. So, switching UL subframe allocation between the FDD and TDD network can be extremely dynamic.

Note that, if desired, UL resource allocation between the FDD LTE 910 and TDD LTE 920 networks can be even more fine-grained than a subframe basis. It is possible to allocate some resource blocks within a single subframe to FDD devices and others to TDD devices. For example, the LTE standard employs SC-FDMA multiple access technique for the UL channel. As such, UL channels from FDD and TDD devices can be assigned to different resource blocks within the same subframe via SC-FDMA scheme.

Finally, it is possible to schedule an FDD LTE 910 UL during what would be a TDD LTE 920 DL or Special subframe. One consideration is that TDD DL control signals used by the TDD LTE UEs to maintain their connections and maintain timing (e.g., P-SS and S-SS broadcast signaling sent over subframes #0 and #5) must be received by the TDD LTE UEs with sufficient regularity or else the UEs may disconnect.

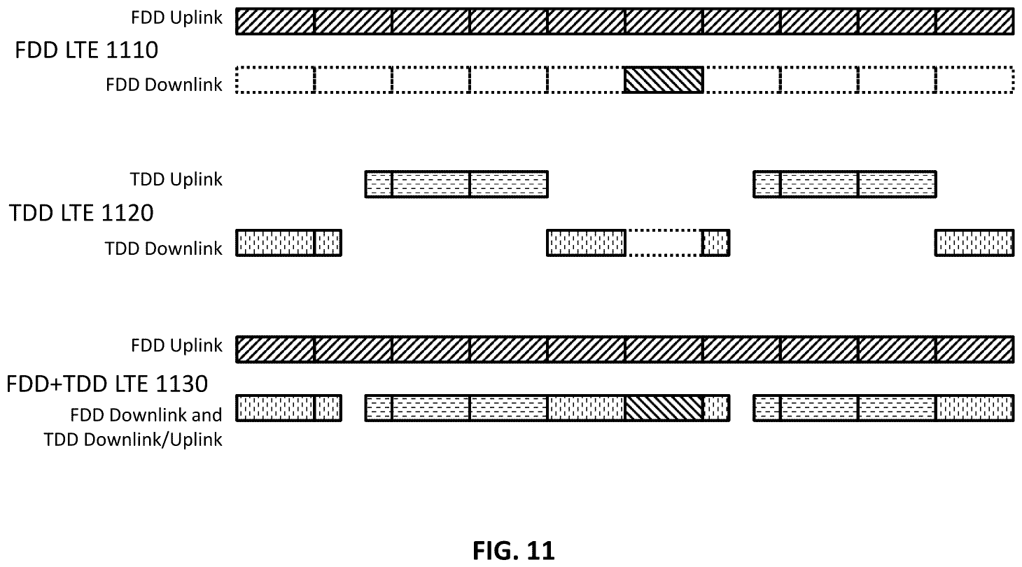

FIG. 11 shows the same concept in FIG. 9 and described above, except the shared channel is the FDD DL channel, not the FDD UL channel. The same subframe filling and outlining designations from FIG. 9 are used in FIG. 11 and as can be seen, the FDD traffic situation is reversed with all of the subframes of FDD LTE 1110 UL channel being used for data while only 1 of the FDD LTE 1110 DL subframes is used for data, while all of the other DL subframes are “idle” and not transmitting data. Similarly, all of the TDD LTE 1120 UL subframes are used for data, while all but one of the TDD LTE 1120 DL subframes are used for data, and in this case the TDD LTE 1120 LTE channel is the same frequency as the FDD LTE 1110 DL channel. The result of the combined FDD LTE 1110 and TDD LTE 1120 networks is shown in the FDD+TDD LTE 1120 channels. As with the example in FIG. 9 the two networks can be controlled by a single controller or by coordination of multiple controllers, with scheduling between them to be sure both networks operate as desired by the network operator with adequate performance to the users and user devices.

Note that the FDD devices attached to the FDD LTE 1110 network are relying on DL transmissions for control and timing information, as well as for data and they must receive adequate control signals on a sufficiently regular basis to remain connected. In one embodiment of the invention, the FDD devices use the broadcast signaling sent by the TDD LTE 1120 network over the DL subframes (e.g., subframes #0 and #5) to obtain time and frequency synchronization. In a different embodiment, subframes #0 and #5 carrying broadcast signaling are assigned to the FDD LTE 1110 network and used to derive time and frequency synchronization at every FDD device.

Although, as described above, typically the FDD DL channel is far more congested than the FDD UL channel, there may be reasons why a mobile operator wishes to share the DL channel. For example, some UL channels are limited to only UL use by the spectrum regulating authority (e.g. there may be concerns about output power interfering with adjacent bands). Also, once a mobile operator begins to offer TDD devices compatible with its FDD spectrum, the mobile operator will likely find these devices to be using spectrum more efficiently than FDD devices and, as such, may discontinue sales of FDD devices. As old FDD devices gradually are replaced and an increasing percentage of devices are TDD, the operator may wish to allocate increasingly more of its spectrum to TDD devices, but still maintain compatibility with the remaining FDD devices in the market.

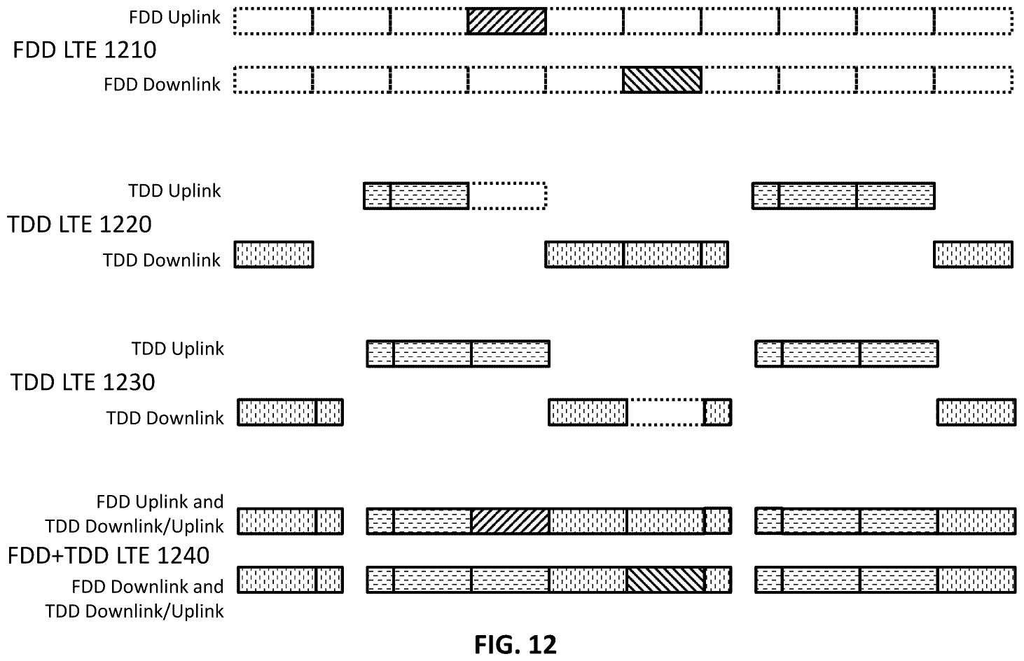

Toward this end, as there are fewer and fewer FDD devices remaining in operation, the operator may decide to use both the UL and DL bands for TDD operation. This is illustrated in FIG. 12 where FDD LTE 1210 only has one subframe in use for UL and one for DL and the remainder are idle. There are two TDD LTE networks 1220 and 1230 each respectively using the FDD LTE 1210 UL and DL channels, resulting the three networks sharing the two channels as show in FDD+TDD LTE 1240. The same flexibilities and constraints apply as described previously, and there can be a single controller of all 3 networks or multiple controllers. The two TDD networks can be operated independently, or by using Carrier Aggregation techniques.

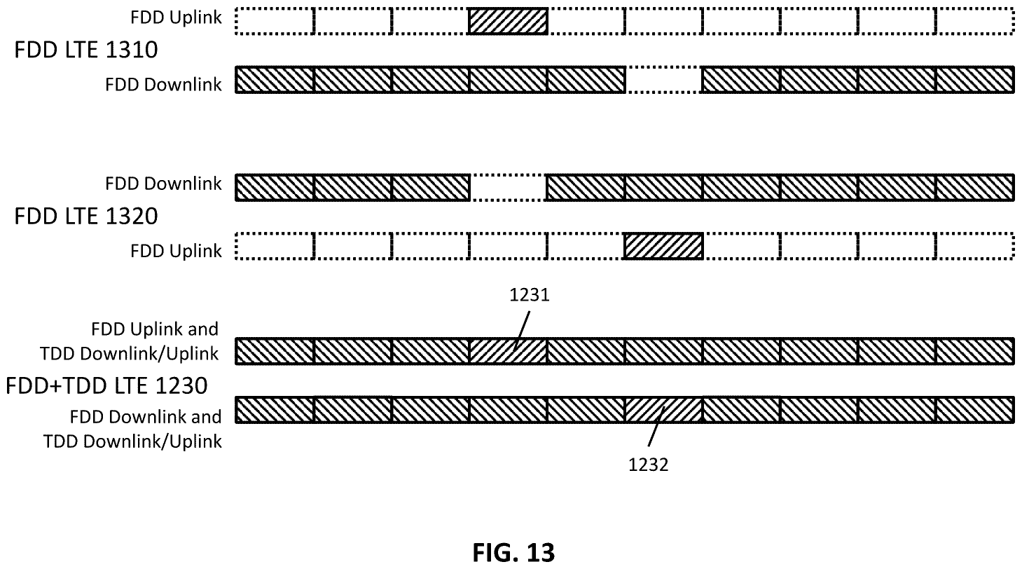

An operator may also choose to forgo TDD altogether but instead add a second FDD network in the same spectrum as an existing FDD network, but with the Uplink and Downlink channels swapped. This is illustrated in FIG. 13 where FDD LTE 1310 network is very asymmetrically utilized in favor of the DL channel, so only one subframe is used for UL, and a second FDD LTE 1320 network is also very asymmetrically utilized in favor of the DL channel, but notice that in FIG. 13 the channel allocation for FDD LTE 1320 is swapped, with the FDD Downlink channel shown above the FDD Uplink channel, contrary to the channel order for FDD LTE 1310 or as shown in prior figures. In the case of both FDD LTE 1310 and 1320, the DL channel leaves one DL subframe idle that corresponds with the one UL frame that is used by the other network. When the networks are combined as shown in FDD+TDD LTE 1230, all of the subframes in both channels are DL, except for subframes 1231 and 1232. Thus, 90% of the subframes are devoted to DL, which better matches mobile traffic patterns as they have evolved than symmetric spectrum allocation for UL and DL.

Also, this structure enables the controller (or controllers) that manage the network to dynamically change the number of UL and DL subframes allocated to each network on a subframe-by-subframe basis, affording extremely dynamic UL/DL traffic adaptation, despite the fact that FDD devices are using both networks.

As with the combined FDD/TDD networks previously described, the same constraints apply for FDD mode in that the LTE devices must receive sufficient control and timing information to remain connected and operate well, and they need sufficiently regular and adequate number of UL frames.

The two FDD networks can be operated independently or through Carrier Aggregation.

In another embodiment, the control information transmitted by the DL channel an existing active network (e.g. in FIGS. 9, 11, 12 and 13 FDD LTE 910, FDD LTE 1110, FDD LTE 1210, or FDD LTE 1310) is used by a new network (or networks) using the same channel (e.g. in FIGS. 9, 11, 12 and 13 TDD LTE 920, TDD LTE 1120, TDD LTE 1220 and TDD LTE 1230, or FDD LTE 1320) to determine which subframes and/or resource blocks and and/or other intervals will be idle. In this way, the new network(s) can determine when it is able to transmit (whether DL or UL) without interfering with the existing active network. This embodiment may make it possible to concurrently use the spectrum of the existing active network without any modification of the existing active network or relying upon any special connection to the existing active network's controller, since it is just a matter of the controller of the new network(s) receiving what is already in the DL transmission from the existing active network. In another embodiment, the only modification to the existing active network is to make sure it enables the new network(s) to transmit essential control and timing information to maintain connections with UEs. For example, the existing active network could be configured to not transmit during times when essential timing and synchronization information are being transmitted, but otherwise operate unmodified.

Although the above embodiments of concurrently supporting networks in the same spectrum used the LTE standard for examples, similar techniques can be utilized with other wireless protocols as well.

### 4. Utilizing Distributed Antenna MU-MAS Concurrently with Actively Used Spectrum

The Distributed Antenna MU-MAS techniques (collectively called “DIDO”) as disclosed in Sections 1 and 2 and in the Related Patents and Applications, dramatically increase the capacity of wireless networks, improve reliability and throughput per device, and make it possible to reduce the cost of devices as well.

In general, DIDO operates more efficiently in TDD than FDD networks because the UL and DL are in the same channel and, as a result, training transmission received in the UL channel can be used to derive channel state information for the DL channel by exploiting channel reciprocity. Also, as described above, TDD mode inherently better suits the asymmetry of mobile data, allowing for more efficient spectrum utilization.

Given that most of the world's current LTE deployments are FDD, by utilizing the techniques disclosed in Section 3, it is possible to deploy a TDD network in spectrum actively used for FDD, and DIDO can be used with that new TDD network, thereby dramatically increasing the capacity of the spectrum. This is particularly significant in that, UHF frequencies propagate far better than microwave frequencies, but most UHF mobile frequencies are already in use by FDD networks. By combining DIDO-based TDD networks with existing FDD networks in UHF spectrum, an exceptionally efficient TDD network can be deployed. For example, Band 44 is a TDD band from 703-803 MHz, overlaying a large number of 700 MHZ FDD bands in the U.S. Band 44 devices could be used concurrently in the same spectrum as 700 MHz FDD devices, enabling DIDO TDD in prime spectrum.

DIDO does not add significant new constraints to the spectrum combining techniques described above. The DRAN 104 shown in FIG. 1 would either replace the existing eNodeBs in the coverage area, or coordinate with the existing eNodeBs 401, as shown in FIG. 4 per the subframe (or resource block) sharing techniques described above.

Notably, if the DIDO system is controlling the entire system and providing the eNodeB for the FDD network, then DIDO can use a training signal such as the SRS UL from the FDD devices so as to decode via spatial processing the UL from multiple existing FDD devices at the same time and within the same frequency band, thus dramatically increasing the spectral efficiency of the existing FDD UL channel and also reducing the UL power required (and/or receiving better signal quality) since the distributed DIDO APs are likely closer to the UEs than a single cellular base station, and also can utilize signal combining techniques, such as maximum ratio combining (MRC) or other techniques as described previously for DIDO.

Thus, DIDO can replace existing eNodeBs and simultaneously use existing spectrum with DIDO TDD devices, while also applying the benefits of DIDO to the UL of the existing FDD devices that are already deployed.

### 5. Mitigating Interference in Actively Used Spectrum

As noted previously, when a TDD network is deployed in either UL or DL frequencies in a band that has been allocated as an FDD band, there may be concerns about output power interfering with adjacent bands. This can be caused by out of band emissions (OOBE) interference and/or receiver “blocking” or receiver “desensitization”. OOBE refers to power emissions outside of the allocated band. OOBE are typically are at highest power in frequencies immediately adjacent to a transmit band and typically diminish as frequencies become more distant to the transmit band. “Receiver blocking” or “receiver desensitization” refers to a receiver's front-end amplifier losing sensitivity to a desired in-band signal due to the presence of a powerful out-of-band signal, typically in a nearby band.

When regulatory authorities (e.g. the FCC) allocate spectrum in adjacent bands for use by multiple mobile operators or other users of spectrum, typically rules are put in place to limit OOBE and power levels so that mobile devices (e.g. mobile phones) and base stations can be manufactured to practical specifications given technology available at the time of the regulatory ruling. Further, consideration is given to existing users of adjacent spectrum and the rules under which those devices were manufactured. For example, a new allocation of spectrum may take into account the availability of technology that will better tolerate OOBE to better reject powerful out-of-band transmissions than technology made during prior spectrum allocations, where older technology was deployed that is more sensitive to OOBE and powerful out-of-band transmissions. Since it is often impractical to replace prior generation base stations and mobile devices, it is necessary for the new deployments to adhere to the OOBE and powerful out-of-band transmission limitations of the prior deployments.

In the case of TDD deployments in FDD bands, there are additional constraints that must be adhered to. In an FDD pair, each of the UL or DL bands was allocated with an expectation of, respectively, UL-only transmissions or DL-only transmissions. Since TDD transmits alternatively in both UL and DL, then if a TDD deployment is operating in a FDD band the was previously allocated as UL-only or DL-only band, then it is operating in a transmit direction that was not anticipated. Thus, to be sure the TDD transmissions do not interfere with previously-defined FDD usage in adjacent spectrum, the TDD transmissions in the opposite direction of the previously-defined FDD usage must meet the emission requirements for the existing usage. For example, if TDD is deployed in an FDD UL band, then the UL part of the TDD transmission should not be a problem, since UL is the direction of previously-defined usage. But, since the DL part of the TDD transmission is in the opposite direction of the previously-defined UL usage, typically the TDD DL transmission must meet the OOBE and powerful out-of-band transmission requirements defined for UL transmissions.

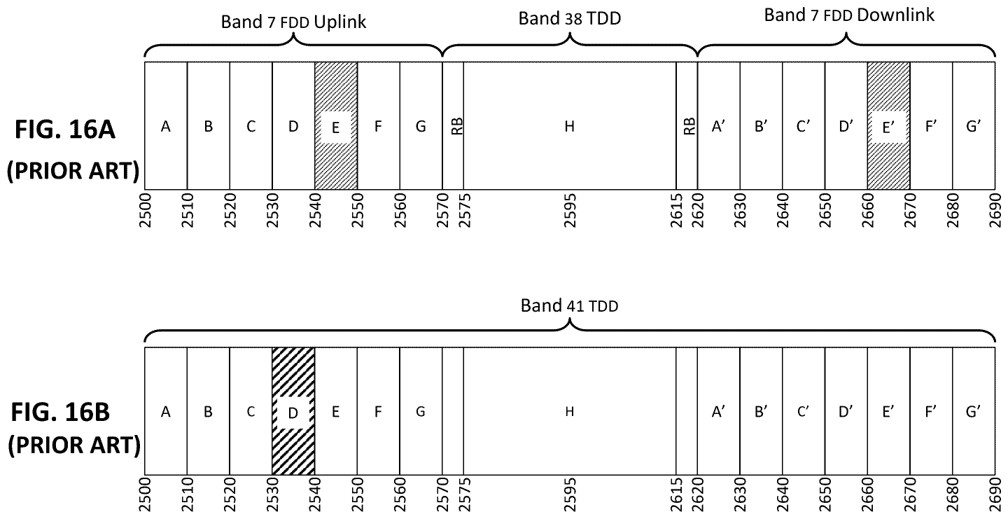

In the case of deploying TDD in an UL band, the UL part of the TDD transmission will typically be a transmission from a mobile device (e.g. a mobile phone). FDD phones in adjacent bands and base stations in adjacent bands will have been designed to tolerate the UL transmissions from mobile phones in adjacent bands. For example, FIG. 16a shows the FDD band 7 UL band divided into sub-bands A through G. FDD mobile phones and base stations operating in shaded sub-band E are designed to tolerate UL transmission in FDD sub-bands A through D, F and G. Thus, if a TDD device is operated in adjacent sub-band D (as shown shaded in FIG. 16b in TDD band 41 sub-band D, the same frequency as FDD band 7 sub-band D), the FDD band 7 mobile phone and base station devices will have no issue with UL part of the TDD transmission in band 41 sub-band D.

But, the DL transmission in TDD band 41 sub-band D is not a scenario that was anticipated in the allocation of FDD band 7 or in mobile phones and base stations designed to operate in that band. Let's consider each device in turn.

In the case of a FDD band 7 mobile phone in sub-band E, it is unlikely to be adversely impacted by base station DL transmissions in adjacent TDD band 41 sub-band D because a mobile phone's band 7 receiver is designed to reject UL transmissions from other mobile phones transmitting in adjacent UL bands. In normal usage, mobile phones might operate within inches of each other (e.g. if two people seated next to each other at a stadium are both making calls) resulting in very high transmit power incident upon each phone's receiver. Technologies (e.g. cavity filters) reject such powerful nearby band transmissions, enabling mobile phones that are physically close to mobile phones using an adjacent band to transmit UL signals without adversely impacting the adjacent mobile phone's DL reception.

But the case of a FDD band 7 base station operating in sub-band E is different. Its receiver was designed to receive UL from mobile devices in FDD band 7 sub-band E and to reject UL from mobiles devices in adjacent FDD band 7 sub-bands A through D, F and G. It was also designed to reject DL transmissions in band 38 TDD sub-band H and band 7 FDD DL in sub-bands A′-H′ shown in FIG. 16a. Thus, the only scenario the FDD band 7 base station was not designed for is to reject DL transmissions from other base stations in sub-band A through D, F and G. We shall consider this case.

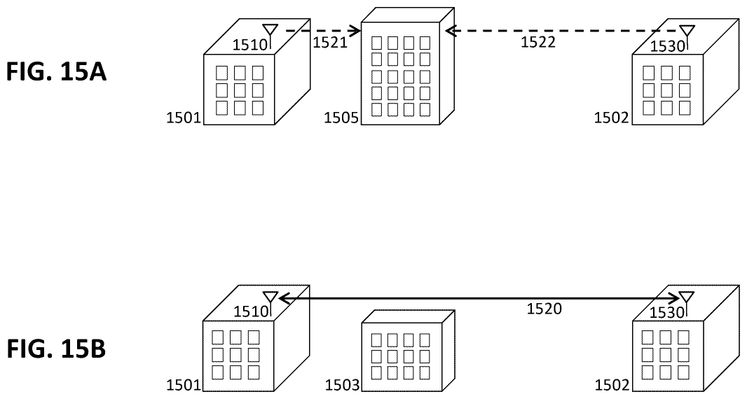

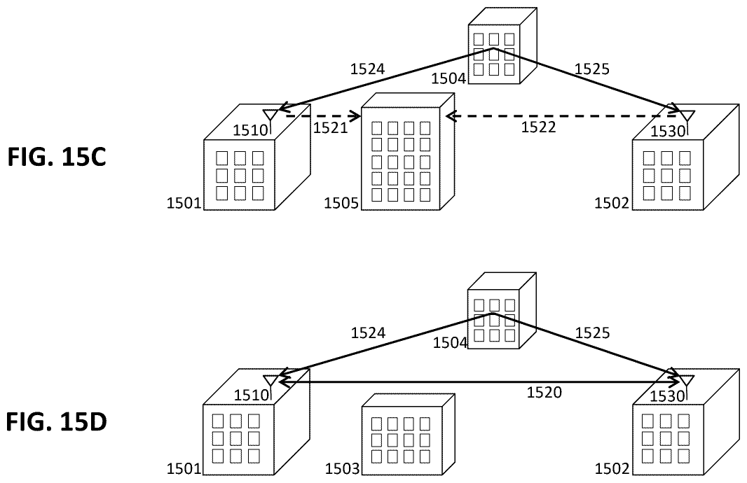

FIGS. 15a, 15b, 15c and 15d consider four transmission scenarios between a TDD band 41 base station (BTS) 1510 on structure 1501 (e.g. a building, a tower, etc.) transmitting in sub-band D and an FDD band 7 base station (BTS) 1530 on structure 1502 receiving in UL sub-band E and transmitting in DL sub-band E′. In scenario:
a. 15a: there no path between TDD BTS 1510 and FDD BTE 1530 because the transmission is completely obstructed by building 1505 and there is no multi-path route around building 1505, and as a result no TDD DL signal will reach FDD BTS 1530.
b. 15b: there is only a Line of Sight (LOS) path between TDD BTS 1510 and FDD BTS 1530. A LOS path will result in a very powerful TDD DL signal reaching FDD BTS 1530.
c. 15c: there is a Non-Line of Sight (NLOS) path between TDD BTS 1510 and FDD BTS 1530, but no LOS path. While it is possible that an NLOS path is via a highly efficient reflector (e.g. a large wall of metal) that is exactly angled such that the signal reaching FDD BTS 1530 approaches the power of an LOS signal, it is statistically unlikely in real-world scenarios that an NLOS path exists that approaches the efficiency of a LOS path. In contrast, what is likely in real-world scenarios is that an NLOS path will be affected by objects that reflect and scatter in a variety of angles as well as objects that absorb and refract the signal to a greater or lesser degree. Further, by definition NLOS paths are longer than LOS paths resulting in higher path loss. All of these factors result in significant path loss in NLOS paths relative to LOS paths. Thus, statistically, it is likely in real-world scenarios that the TDD DL NLOS signal power received by the FDD BTS 1530 will be much less than the TDD DL LOS signal power received by the FDD BTS 1530 as illustrated in FIG. 15b.
d. 15d: there is both an LOS and NLOS path between TDD BTS 1510 and FDD BTS 1530. This scenario is effectively the sum of scenarios 15b and 15c, resulting in the FDD BTS 1530 receiving the sum of a very powerful signal from the LOS path from TDD BTS 1510 as well as a statistically much weaker signal from the NLOS path from TDD BTS 1510.

In considering the four scenarios of the previous paragraph, clearly scenario 15a presents no issue at all since there is no signal received by FDD BTS 1530. NLOS scenario 15c results in some TDD DL BTS 1510 signal reaching FDD BTS 1530, but statistically it is a much weaker signal than an LOS signal. Further, in the unlikely, but possible, scenario where an NLOS path is a highly efficient reflector, then that can often be mitigated by site planning, e.g., repositioning or repointing the TDD DL BTS 1510 antenna such that the NLOS path is not efficiently reflected. Scenarios 15b (LOS) and 15d (LOS+NLOS) are the problematic scenarios because of the LOS component in each resulting in a high power signal in an adjacent band, which the FDD BTS 1530 was not designed to tolerate.

While the NLOS components of scenarios 15c and 15d certainly can result in a lower power signal received by the FDD BTS 1530 in an adjacent UL band, the FDD BTS 1530 is designed to reject lower power, largely NLOS signal from the entire UL band from mobile devices, e.g., using cavity filters. Thus, if the LOS component of scenarios 15b and 15d can be mitigated, leaving only a lower power (e.g. avoiding unlikely highly efficient reflections) NLOS signal component from scenarios 15c and 15d, then this would result in the FDD BTS 1530 only receiving transmissions in the UL band at power levels it was designed to tolerate and would thus enable DL transmissions from TDD BTS 1510 in the UL band without disrupting the operation of the FDD BTS 1530. As noted previously, no other transmission direction in the FDD UL band will disrupt adjacent band operation and, thus, if the TDD DL BTS 1510 LOS transmission component to the FDD BTS 1530 can be mitigated, then FDD UL bands can be used for TDD bi-directional operation without disrupting adjacent band FDD operation.

As previously disclosed in the Related Patents and Applications, a multi-user multi-antennas system (MU-MAS), such as the DIDO system, the technology marketed under pCell™ trademark, or other multi-antenna systems are able to utilize channel state information (CSI) knowledge from the location of a user antenna to either synthesize a coherent signal at the location of the user antenna, or synthesize a null (i.e. zero RF energy) at that location. Typically, such CSI is determined from an in-band (IB) training signal, either transmitted from the base station to the user device, with the user device responding with CSI information, or transmitting from the user device to the base station, with the base station exploiting reciprocity to determine CSI as the location of the user antenna.

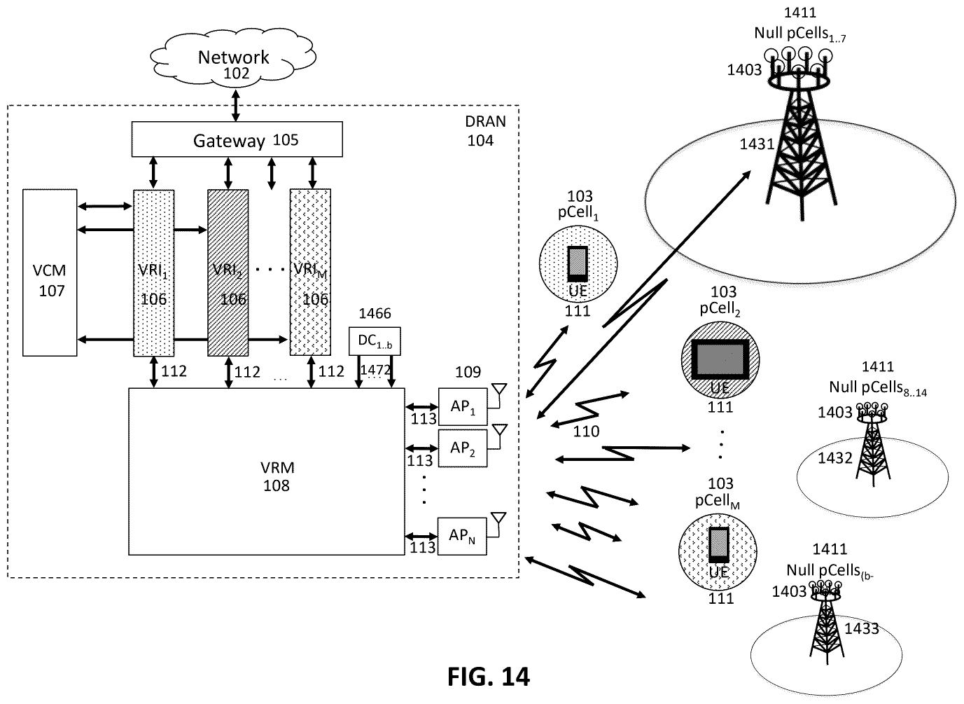

In one embodiment the MU-MAS system as depicted in FIG. 14 and operates as described in Sections 1-4, above, estimates the CSI at each UE location 111, synthesizing independent pCells 103 (pCell₁, pCell₂, . . . pCell_{M}) in the same frequency band at each UE location 111 with the signal from each of the respective VRIs 106 (VRI₁, VRI₂, . . . VRI_{M}). In addition to estimating the CSI at each UE location 111 as described in Section 1-4 above, in this embodiment the MU-MAS system also estimates CSI at each antenna 1403 shown on structures 1431-1433 and as it synthesizes pCells 103 at each location 111, it also concurrently synthesizes pCells 1411 (pCells 1 . . . 7, 8 . . . 14, and (b-6) . . . b, (collectively, pCells_{1 . . . b})) at the location of each antenna 1403, with all pCells in the same frequency band. But unlike pCells 103, which each contains a synthesized waveform from its respective VRI, each pCell 1411 is a null with zero RF energy.

In one embodiment the null pCells 1411 described in the previous paragraph are synthesized by instantiating VRIs 1466 that input flat (Direct Current (DC_{1 . . . b})) signals to the VRM 108. In another embodiment, they are calculated within the VRM as null locations using techniques previously disclosed in the Related Patents and Applications for synthesizing null signal (zero RF energy) contributions at antenna locations.

When an in-band (“IB”) training signal is used to estimate the CSI at the location of each antenna 1403, a highly accurate CSI estimation will result, using the techniques described in Sections 1 through 4 and in the Related Patents and Applications. For example, if the pCell transmission band is from 2530 to 2540 MHz, band D in FIG. 16b, if a training signal in the same frequency range of 2530 to 2540 is used, a highly accurate CSI estimation will result. But when an out-of-band (“OOB”) signal (e.g. at 2660 to 2670 MHz) is used to estimate the CSI at the location of an antenna instead of an IB signal (e.g. at 2530 to 2540 MHZ, band E′ in FIG. 16a), such an OOB CSI estimate will only be reasonably accurate if the channel is “frequency flat” between the IB and OOB frequencies. Frequency flat means that the channel has flat fading in both the IB and OOB frequencies, such that the signals in each of the IB and OOB frequencies experience the same magnitude of fading. If the IB and OOB frequencies have selective fading, i.e. frequency components of IB and OOB frequencies experience uncorrelated fading, then using the CSI estimate obtained from an OOB signal may not be very accurate for an IB signal. Thus, if band E′ of FIG. 16a is frequency flat relative to band D of Fig. b then a training signal in band E′ can be used to obtain a highly accurate CSI for band D. But, if band E′ has significant selective fading relative to band D, then a training signal from band E′ will not result in an accurate CSI for band D.

A purely LOS signal in free space where there is no NLOS component (e.g. as illustrated in FIG. 15b) is in a frequency-flat channel. Thus, if the only component to the signal is LOS, then an OOB signal can be used to accurately estimate the CSI for an IB signal in at the location of a user antenna. In many real-world deployments, however, there is not a purely LOS signal, but rather there is either no signal at all (e.g. FIG. 15a), only an NLOS signal (e.g. FIG. 15c) or a combined LOS and NLOS signal (e.g. 15d).

If an OOB signal is used to estimate the CSI of FDD BTS 1530's antenna from the perspective of TDD BTS antenna 1510, then the following be the results for each of the scenarios in FIGS. 15a, 15b, 15c and 15d:
a. 15a: no signal, so no CSI will result.
b. 15b: LOS-only will result in CSI that is consistently accurate.
c. 15c: NLOS-only will result in CSI that is not consistently accurate due to the likelihood of selective fading from the NLOS-only channel.
d. 15d: LOS+NLOS that, the resulting CSI will be a combination of CSI components where the NLOS component is not consistently accurate and LOS component is consistently accurate.

We refer to the CSI derived from a pure LOS channel as C_{L}, the CSI derived from a pure NLOS channel as C_{N}, and the CSI derived from a channel with a combination of pure LOS and pure NLOS components as C_{LN}. The CSI of a combined LOS and NLOS can then be formulated as C_{LN}=C_{L}+C_{N}.

In the case of a pure LOS channel between Access Points 109 (AP_{1 . . . N}) and antennas 1403 in FIG. 14, then the only CSI component is a C_{L} for each antenna 1403. Since pure LOS channels are frequency flat, if an OOB signal is used for the deriving the CSI, the CSI for each antenna 1403 will still be accurate. Thus, when using an OOB signal to derive the CSI, the LOS signal from each AP 109 will be nulled with a high degree of accuracy at the location of each antenna 1403, resulting in little or no detectable signal by each antenna 1403 from the transmissions of APs 109.

In the case of a pure NLOS channel between APs 109 and the antennas 1403, then the only CSI component for is a C_{N} for each antenna 1403. If an OOB signal is used for the deriving the CSI, the CSI for each antenna 1403 will be more or less accurate, depending on how frequency flat the channel is. Thus, when using an OOB signal to derive the CSI, the NLOS signal from each AP 109 will be either nulled completely (in the case of a perfectly frequency-flat channel), partially nulled, or not nulled at all, depending on the degree of channel frequency selectivity. To the extent the NLOS signals are not nulled, each antenna 1403 will receive some random summation of the NLOS signals from the APs 109. Thus, there may be some reduction in the NLOS signal strength from APs 109 to the antennas 1403, but the NLOS signal strength will be no higher than NLOS signal strength than would have been received had no CSI been applied to attempt to null the NLOS signals.

In the case of a combined LOS and NLOS channel between APs 109 and the antennas 1403, then the CSI is a combination of LOS and NLOS components C_{LN}=C_{L}+C_{N} for each antenna 1403. If an OOB signal is used for the deriving the CSI, the C_{L} component of the CSI for each antenna 1403 will be highly accurate and CSI for C_{N} component will be more or less accurate, depending on how frequency flat the channel is. The C_{L} component of the CSI affects the nulling of the LOS component of the signal between the APs 109 and the antennas 1403, while the C_{N} component of the CSI affects the nulling of the NLOS component of the signal between the APs 109 and the antennas 1403. Thus, when using an OOB signal to derive the CSI, the LOS signal from each AP 109 will be consistently nulled completely, while the NLOS signal from each AP 109 will be nulled to a greater or lesser degree, depending on the degree of channel frequency selectivity. So, in sum, the LOS components of the transmissions from APs 109 will be completely nulled, and NLOS components of the transmissions from APs 109 will have no greater signal strength than would have been received by the antennas 1403 had no CSI been applied to attempt to null the NLOS signals.

As previously noted above, in the scenarios shown in FIGS. 15a, 15b, 15c, and 15d, the problematic scenarios are when the LOS component of TDD BTS 1510 is received by FDD BTS 1530. It is generally not a problem when the NLOS component of TDD BTS 1510 is received by FDD BTS 1530. Consider the MU-MAS embodiment described in the preceding paragraphs: If TDD BTS 1510 is one of the APs 109 from FIG. 14 and FDD BTS 1530 is one of the antennas 1403, then if the training signal used to determine the CSI for antennas 1403 is an IB signal, then transmission from TDD BTS 1530 will be completely nulled at FDD BTS 1530. If the training signal used to determine the CSI for antennas 1403 is an OOB signal, then the LOS transmission from TDD BTS 1530 will be completely nulled at FDD BTS 1530, and the NLOS transmission from TDD BTS 1530 to FDD BTS 1530 will be no worse than if no CSI had been applied to attempt to null the NLOS signals. Thus, an OOB training signal from antenna 1530 will completely null any LOS component of a transmission from antenna 1510, but will neither reliable null nor make any stronger any NLOS component of a transmission from antenna 1510.

Since only the LOS component of the signal transmitted from antenna 1510 is problematic and it has been nulled, and NLOS component of antenna 1510 is not problematic and won't be made any worse, we thus have an embodiment in which a TDD BTS 1530 can operate in a MU-MAS system such as that shown in FIG. 14 in FDD UL spectrum without significantly disrupting the receiver performance of an adjacent band FDD BTS, provided that at least an OOB signal from the FDD BTS is available.

In the case of many FDD systems, such an OOB signal is indeed available. For example, in FIG. 16a, the FDD BTS 1530 that is receiving UL in sub-band E is concurrently transmitting DL in sub-band E′. While data traffic may vary in the DL sub-band, the control signals typically (e.g. in the LTE standard) are transmitted repeatedly. So, at a minimum, these DL control signals can be used as the OOB training signal used for determining the CSI of the FDD BTS 1530, utilizing reciprocity techniques previously disclosed in the Related Patents and Applications, and applying the CSI derived from channel reciprocity of the DL transmission from FDD BTS 1530 (corresponding to antennas 1403 in FIG. 14) in sub-band E′ to create a null at FDD BTS 1530 (corresponding to antennas 1403 in FIG. 14) in sub-band D concurrently with the TDD DL transmission from TDD BTS 1510 (corresponding to APs 109 in FIG. 14) to UEs at locations 111. The LOS component of the sub-band D TDD DL transmission from TDD BTS 1510 (corresponding to APs 109 in FIG. 14) will be completely nulled at FDD BTS 1530 (corresponding to antennas 1403 in FIG. 14), while the NLOS component of the sub-band D TDD DL transmission will be no worse that it would be had been had there been no nulling of the LOS component.

In addition to creating a null for TDD DL transmissions at the location of FDD BTS locations 1530 within the bandwidth of the TDD DL transmissions, it is desirable to also null high power OOBE from the TDD DL transmission at the FDD BTS locations. Because the OOBE from the LOS component is in a frequency-flat channel, then nulling of the in-band LOS component will also null the OOBE from the LOS component. However, to the extent the NLOS component is in a frequency-selective channel, the OOBE of the NLOS component will not be nulled, but it will be no worse than the OOBE from the NLOS would have been had there been no attempt to null the LOS component. The power of the OOBE of each of the LOS and NLOS transmissions is proportionate to the power of the in-band LOS and NLOS transmissions, respectively. Thus, nulling the OOBE of the LOS transmission, and making the OOBE of the NLOS transmission no worse than it would otherwise have been, addresses the highest-power and most problematic OOBE component, LOS, will making the less-problematic NLOS component no worse.

FDD base stations typically have multiple antennas for diversity, beamforming, MIMO or other reasons. This scenario is depicted in FIG. 14 where there are multiple antennas 1411 on each structure 1431-1433. So, rather than the single FDD BTS antenna 1530 depicted in FIGS. 15a, 15b, 15c and 15d, typically there would be multiple FDD BTS antennas 1411. To the extent any such antennas are transmitting, then the MU-MAS system described above and depicted in FIG. 14 would receive a transmission from each of the antennas 1411 that it would use to derive the CSI for each antenna and null the LOS component of the APs 109 transmissions to that antenna. In another embodiment, nulls would only be created for some of the BTS antenna 1411. For example, some of the antennas 1411 might not be used in UL reception, and it would be unnecessary to create a null for them.

In a wide-scale deployment of the above embodiments, many TDD BTS antennas and adjacent sub-band FDD BTS antennas would be distributed throughout a large coverage area (e.g. a city, a region, a country or a continent). Clearly, not all antennas would be within range of each other, and as such it would only be necessary to null a TDD BTS DL transmission that is of sufficient power levels to interfere with a given FDD BTS antenna. In one embodiment, the VRM 108 receives from TDD BTS DL APs 109 transmissions from FDD BTS antennas 1403 and assesses the power level incident from the TDD BTS APs 109 upon each FDD BTS antenna 1403 from each TDD BTS AP 109. Various means can be used to make this assessment, including utilizing channel reciprocity. The VRM 108 only synthesizes nulls at the FDD BTS antennas 1403 that would be receiving OOBE or receiver blocking/receiver desensitization power above a given threshold. The threshold can be set to any level, including, but not limited thresholds that are determined to be an interfering threshold or a threshold established by spectrum regulations.

The null pCells 1411 are similar to pCells 103 transmitting a signal in that they require computing resources and AP 109 resources. Thus, it is advantageous to minimize the number of AP 109 resources needed to create null pCells throughout the coverage area. In another embodiment clustering techniques such as those previously disclosed in the Related Patents and Applications can be utilized to reduce the number of APs 109 needed to synthesize the pCells 103 needed for user devices and pCells 1411 needed to null antennas 1403 throughout the coverage area.

The embodiments described above address creating nulls at FDD DL antennas that have no knowledge of the TDD operation in adjacent spectrum. In another embodiment the FDD DL antennas do have knowledge of the TDD operation in adjacent spectrum and cooperate with the TDD system. In one embodiment, the FDD DL antennas 1403 regularly transmit a training signal within the TDD band (e.g. such as the LTE SRS signal) the enables the MU-MAS system in FIG. 14 to have an IB reference for determining accurate CSI for the FDD DL antennas 1403. With accurate CSI the VRM 108 will be able to synthesize a null for both the LOS and NLOS components, thus enabling a very high power TDD DL transmission to be used in adjacent spectrum since even the NLOS signal will be nulled. In another embodiment the FDD DL transmission is timing and/or frequency interleaved with training signals from either the UEs (such as SRS) or the TDD DL BTS. In another embodiment the FDD DL antennas 1403 also transmit an IB training signal in their own UL spectrum (e.g. choosing a time when there is no concurrent UL activity) that the VRM 108 can use to determine the OOBE CSI and create nulls for both the NLOS as well as the LOS OOBE.

In another embodiment the antennas 1403 are TDD antennas used in adjacent TDD spectrum. When adjacent TDD systems are synchronized in UL and DL, then interference from OOBE and receiver blocking/receiver desensitization is minimized since all BSTs are in transmit or receive mode at the same time. Sometimes there is a need to have adjacent TDD system operate without synchronizing DL and UL times, for example, if adjacent networks require different DL and UL ratios or if they have different latency requirements, e.g., if one network needs more frequent DL or UL intervals to reduce round-trip latency. In these scenarios, adjacent bands will be in use with UL and DL at the same time. The same techniques described above can be used for one or both systems to synthesize nulls at the BST antennas of the other system during DL intervals. Per the techniques described above, one or both of the in-band and the OOBE transmissions can be nulled, either nulling the LOS component or the NLOS component as well.

In one embodiment the same spectrum for the MU-MAS system in FIG. 14 is used to provide terrestrial wireless services while it is concurrently used as a DL band (i.e. with transmissions directed skyward) for aircraft. Even though the MU-MAS system is intended for terrestrial use, to the extent the aircraft falls within the antenna pattern of the APs 109 the path from the APs 109 to the aircraft will be LOS or largely LOS and potentially could interfere with the DL to the aircraft. By receiving the UL (i.e. transmission directed to the ground) from the aircraft, the VRM can derive the CSI to the aircraft antennas using the techniques described previously and thus synthesize a null at the locations of the aircraft antennas. Since the path to the aircraft is LOS, the CSI can be quite accurate, even if the aircraft UL signal is OOB. Thus, in this way spectrum can be concurrently used with aircraft DL. This is a very efficient use of spectrum since aircraft do not fly by very often and if spectrum were reserved exclusively for aircraft, it would be inactive most of the time.

In another embodiment the aircraft's antenna(s) are treated as one or more UEs along with the terrestrial UEs, and when the aircraft flies within range of the MU-MAS system show in FIG. 14, it uses UL and DL capacity the same as any other UEs. Multiple antennas can be used on the aircraft to increase capacity. The antennas can be located spread apart from each other on or in the aircraft and can be polarized to increase capacity. Individuals within the aircraft can also use their own devices (e.g. mobile phones) in the same spectrum, connected to the same MU-MAS. The MU-MAS would create independent pCells for the aircraft antennas and for the user UEs.

Embodiments of the invention may include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the figures can be implemented using code and data stored and executed on one or more electronic devices. Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical or other form of propagated signals-such as carrier waves, infrared signals, digital signals, etc.).

Throughout this detailed description, for the purposes of explanation, numerous specific details were set forth in order to provide a thorough understanding of the present invention. It will be apparent, however, to one skilled in the art that the invention may be practiced without some of these specific details. In certain instances, well known structures and functions were not described in elaborate detail in order to avoid obscuring the subject matter of the present invention. Accordingly, the scope and spirit of the invention should be judged in terms of the claims which follow.

We claim:

1. A wireless transceiver station configured to create a plurality of concurrent and independent orthogonal frequency-division multiplexing (“OFDM”) wireless links between the wireless transceiver station and a plurality of user devices within a same frequency band, the plurality of wireless links formed over multipath downlink or uplink channels;
wherein the wireless transceiver station comprises one or more computer processors that carry out instructions embodied in a non-transitory computer readable medium so that the wireless transceiver station is configured to create the plurality of concurrent and independent OFDM wireless links using a number of wireless transceiver station antennas equal to more than ten times a number of antennas configured to communicate over at least one of the uplink channels of the plurality of concurrent and independent OFDM wireless links of at least one user device;
wherein the wireless transceiver station is configured to create at least one of the plurality of concurrent and independent OFDM wireless links with at least one user device's antennas in or on an aircraft flying within the coverage area of the wireless transceiver station and at least one of the plurality of concurrent and independent OFDM wireless links with at least one user device's antennas; and
wherein the wireless transceiver station is configured to exploit channel reciprocity by estimating an uplink channel state information (CSI) between the plurality of antennas on the wireless transceiver station and one or more of the antennas of the plurality of user devices and using it to derive a downlink CSI.

2. The wireless transceiver station as in claim 1 wherein the wireless transceiver station is configured to estimate a CSI between the plurality of antennas on the wireless transceiver station and one or more of the antennas of the plurality of user devices by using pilot tones, channel sounding or training signals.

3. The wireless transceiver station as in claim 1 wherein the wireless transceiver station is configured to estimate a CSI between the plurality of antennas on the wireless transceiver station and one or more of the antennas of the plurality of user devices by training signals that are orthogonal.

4. The wireless transceiver station as in claim 1 wherein the wireless transceiver station is configured to store a CSI estimate between the plurality of antennas on the wireless transceiver station and one or more of the antennas of the plurality of user devices in a channel characterization matrix.

5. The wireless transceiver station as in claim 1 wherein the wireless transceiver station is configured to store a CSI estimate between the plurality of antennas on the wireless transceiver station and one or more of the antennas of the plurality of user devices in a channel characterization matrix comprised of phase and amplitude of the channel.

6. The wireless transceiver station as in claim 1 wherein the wireless transceiver station is configured to direct user devices to transmit training signals.

7. The wireless transceiver station as in claim 1 wherein the wireless transceiver station is configured to direct user devices to transmit training signals that are synchronized.

8. The wireless transceiver station as in claim 1 wherein the wireless transceiver station is configured to update a CSI estimate between the plurality of antennas on the wireless transceiver station and one or more of the antennas of the plurality of user devices continually or periodically.

9. The wireless transceiver station as in claim 1 wherein the wireless transceiver station is configured to update a CSI estimate between the plurality of antennas on the wireless transceiver station and one or more of the antennas of the plurality of user devices as the user devices move from one location to another.

10. The wireless transceiver station as in claim 1 wherein the wireless transceiver station is configured to create the plurality of concurrent and independent OFDM wireless links via precoding based on a plurality of CSI estimates between the plurality of antennas on the wireless transceiver station and one or more of the antennas of the plurality of user devices.

11. The wireless transceiver station as in claim 1 wherein the wireless transceiver station is configured to divide the user devices into groups.

12. The wireless transceiver station as in claim 1 wherein the wireless transceiver station is configured to divide the user devices into groups and schedule different groups of users by cycling between groups.

13. The wireless transceiver station as in claim 1 wherein the wireless transceiver station is configured to divide the user devices into groups and assign the same or different levels of bandwidth to the user devices.

14. The wireless transceiver station as in claim 1 wherein the wireless transceiver station is configured to divide the user devices into groups and schedule different groups based on relative proximity between the user devices.
